(19) United States
(12) Patent Application Publication
(10) Pub. No.: US 2026/0362420 A1
(43) Pub. Date: Nov. 12, 2026

(54) DOWNLINK-UPLINK REUSE IN A DISTRIBUTED BASE STATION

(71) Applicant: Outdoor Wireless Networks LLC, Richardson, TX (US)

(72) Inventors: Ehsan Daeipour, Southborough, MA (US); Minyan Shi, Bolton, MA (US)

(73) Assignee: Outdoor Wireless Networks LLC, Richardson, TX (US)

(21) Appl. No.: 19/134,873

(22) PCT Filed: Nov. 21, 2023
(86) PCT No.: PCT/US2023/080753

§ 371 Date: Jun. 2, 2025

Related U.S. Application Data
(60) Provisional application No. 63/386,105, filed on Dec. 5, 2022.

(51) Int. Cl. H04W 72/1273; H04B 7/06; H04L 5/00

(52) U.S. Cl. CPC H04W 72/1273; H04B 7/0626; H04L 5/0051

(57) ABSTRACT

A communication system for downlink/uplink reuse in a same time and frequency resource. The communication system includes a plurality radio unit (RUs) in a cell. A first set of RUs serves a first user equipment (UE), and a second set of RUs serves second UEs. The communication system also includes a central entity communicatively coupled to the plurality of radio units via a fronthaul network. The central entity is configured to schedule the first UE for uplink transmission on at least one symbol and at least one frequency. The central entity is also configured to schedule a second UE, based on interference from the first UE reflected in the second UE's channel state information, for downlink on the at least one symbol and the at least one frequency (the same symbol that the first UE is scheduled on for UL transmission).

### BACKGROUND

This application claims the benefit of U.S. Provisional Patent Application Ser. No. 63/386,105 (Attorney Docket 6618 US PI/100.2105USPR) filed on Dec. 5, 2022, entitled “DOWNLINK-UPLINK REUSE IN A DISTRIBUTED BASE STATION”, the entirety of which is incorporated herein by reference.

### BACKGROUND

User equipment terminals (UEs) can be configured in downlink (DL) reuse in which multiple UEs receive on the same airlink resource(s) or uplink (UL) reuse in which multiple UEs transmit on the same airlink resource(s). It may be beneficial to configure at least one UE in the downlink and at least one UEs in the uplink being serviced in the same timeslot and same frequency.

### SUMMARY

A communication system for downlink/uplink reuse in a same time and frequency resource. The communication system includes a plurality radio unit (RUs) in a cell. A first set of RUs serves a first user equipment (UE), and a second set of RUs serves second UEs. The communication system also includes a central entity communicatively coupled to the plurality of radio units via a fronthaul network. The central entity is configured to schedule the first UE for uplink transmission on at least one symbol and at least one frequency. The central entity is also configured to schedule a second UE, based on interference from the first UE reflected in the second UE's channel state information, for downlink on the at least one symbol and the at least one frequency (the same symbol and the same (or partially overlapping) frequency that the first UE is scheduled on for UL transmission).

A method for downlink/uplink reuse in a same time and frequency resource. The method is performed by a central entity that is communicatively coupled with a first set of RUs in a cell that serve a first user equipment (UE) and a second set of RUs in the cell that serve second UEs. The method includes scheduling the first UE for uplink transmission on at least one symbol and at least one frequency. The method also includes scheduling a second UE, based on interference from the first UE reflected in the second UE's channel state information, for downlink on the at least one symbol and the at least one frequency (the same symbol and the same (or partially overlapping) frequency that the first UE is scheduled on for UL transmission).

### DRAWINGS

Understanding that the drawings depict only exemplary configurations and are not therefore to be considered limiting in scope, the exemplary configurations will be described with additional specificity and detail through the use of the accompanying drawings, in which:

FIG. 1A is a block diagram illustrating an exemplary configuration of a Next Generation NodeB (also referred to here as an “gNodeB” or “gNB”) implemented using a C-RAN;

FIG. 1B is a block diagram illustrating another exemplary configuration of an Evolved Node B (also referred to here as an “eNodeB” or “eNB”) implemented using a C-RAN that employs at least one baseband unit and one or more radio units;

FIG. 2 is a block diagram illustrating a downlink (DL) reuse scenario (on the left of FIG. 2) and a downlink/uplink (DL/UL) reuse scenario (on the right of FIG. 2);

FIG. 3A is a block diagram illustrating cross-RU interference measurement;

FIG. 3B is a block diagram illustrating cross-RU interference between a plurality of RUs;

FIG. 4 is a block diagram illustrating cross-UE interference measurement;

FIG. 5A is a block diagram illustrating a first DL/UL reuse configuration;

FIG. 5B is a block diagram illustrating a second DL/UL reuse configuration;

FIGS. 6A-B are block diagrams illustrating examples of where to measure the cross-UE interference within an RB;

FIG. 7A is a block diagram illustrating possible comb2 configurations 130A for transmitting a Sounding Reference Signal (SRS);

FIG. 7B is a block diagram illustrating possible comb4 configurations 130B for transmitting a Sounding Reference Signal (SRS);

FIG. 8 is a block diagram illustrating CSI-IM, ZP-CSI-RS, and SRS configurations for the examples below;

FIG. 9 is a block diagram illustrating a TDD pattern 120 that includes downlink slots (or symbols within slots), uplink slots (or symbols within slots), and optionally flexible slots (or symbols within slots);

FIGS. 10A-C are exemplary 10-slot groupings that could be defined in a common configuration and used in TDD UL/DL reuse;

FIG. 11 is a flow diagram illustrating a method for DL/UL reuse in the same time and frequency resource; and

FIG. 12 is a block diagram of a plurality of RUs 106A-K in an example system.

In accordance with common practice, the various described features are not drawn to scale but are drawn to emphasize specific features relevant to the exemplary configurations.

### DETAILED DESCRIPTION

Downlink reuse (or DL reuse) in a distributed base station hierarchy includes serving multiple UEs concurrently using the same time-frequency resource(s). Generally, each RU in a downlink reuse layer would communicate with different, geographically diverse UEs, e.g., where a first set of RU(s) communicating with a first UE are sufficiently RF-isolated from a second set of RU(s) communicating with a second UE (both the first UE and the second UE being in downlink frequency reuse).

Similarly with uplink (UL) reuse includes concurrently servicing multiple users on the UL using the same time-frequency resource(s). Generally, each UE in an uplink reuse layer would communicate with different, geographically diverse RU(s), e.g., where a first set of RU(s) communicating with a first UE are sufficiently RF-isolated from a second set of RU(s) communicating with a second UE (both the first UE and the second UE being in uplink frequency reuse).

Typically, two UEs served by the same distributed base station can be in UL reuse or DL reuse. However, the unpaired frequency bands used by Time Division Duplexing (TDD) in 5G new radio (NR) allows gNBs to dynamically reconfigure frame configurations between DL, special (a slot where DL to UL switching happens), and UL with certain constraints. Thus, the present systems and methods configure at least one UE in the downlink and at least one UEs in the uplink being serviced in the same timeslot and same frequency. As the TDD bands are unpaired, one challenge is avoiding interference between DL UE and UL UE on the same timeslot in the same frequency.

### Example 5G C-RAN

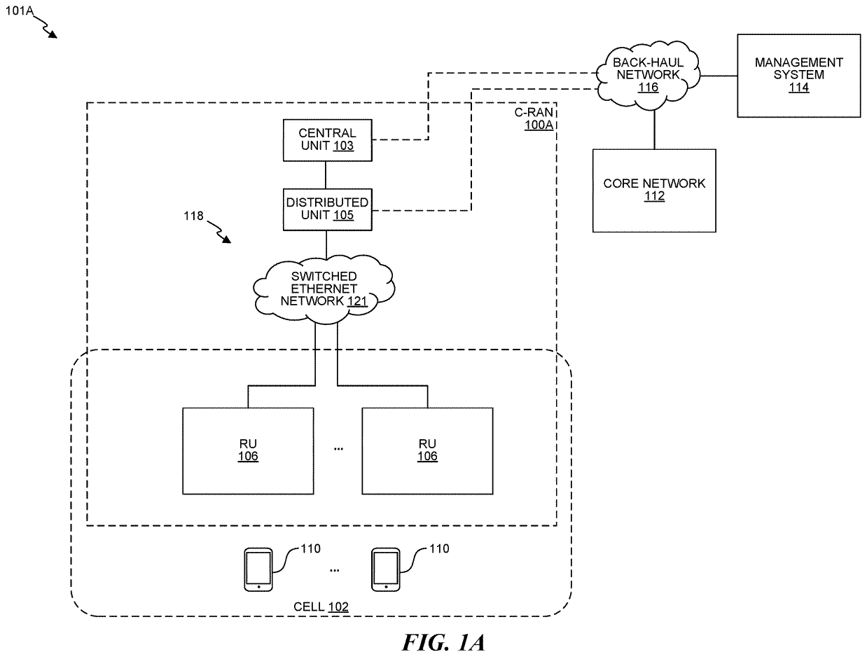

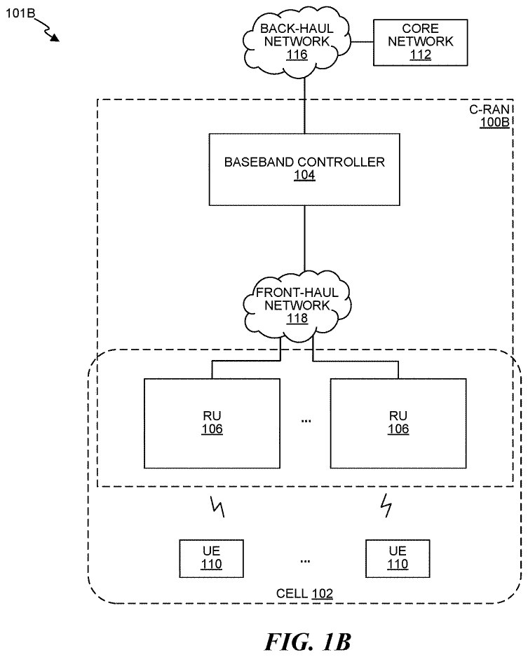

FIG. 1A is a block diagram illustrating an exemplary configuration of a Next Generation NodeB (also referred to here as an “gNodeB” or “gNB”) 100A implemented using a C-RAN. In the exemplary configuration of FIG. 1A, the gNB 100A can be implemented as a Fifth Generation New Radio (5G NR) RAN that supports a 5G NR air interface in accordance with the 5G NR specifications and protocols promulgated by the 3rd Generation Partnership Project (3GPP). Thus, in some configurations, the C-RAN 100A can also be referred to as a “Next Generation Node B”, “gNodeB”, or “gNB”.

In the exemplary embodiment shown in FIG. 1A, the gNB 100A employs a centralized or cloud RAN (C-RAN) architecture for each cell (or sector) served by the gNB 100A, with the following logical nodes: at least one control unit (CU) 103, at least one distributed unit (DU) 105, and multiple radio units (RUs) 106. Each RU 106 is remotely located from each CU 103 and DU 105 serving it. Also, in this exemplary embodiment, at least one of the RUs 106 is remotely located from at least one other RU 106 serving that cell 102. In some configurations, all RUs 106 serve the same cell 102 or cells 102. Every RU 106 in the system 100A may transmit the same or different cell-ID for the cell(s) 102 they all serve.

The C-RAN 100A can be implemented in accordance with one or more public standards and specifications. In some configurations, the C-RAN 100A is implemented using the logical RAN nodes, functional splits, and front-haul interfaces defined by the O-RAN Alliance. In such an O-RAN example, each CU 103, DU 105, and RU 106 can be implemented as an O-RAN central unit (CU), O-RAN distributed unit (DU), and O-RAN radio unit (RU), respectively, in accordance with the O-RAN specifications.

That is, each CU 103 comprises a logical node hosting Packet Data Convergence Protocol (PDCP), Radio Resource Control (RRC), Service Data Adaptation Protocol (SDAP), and other control functions. Therefore, each CU 103 implements the gNB controller functions such as the transfer of user data, mobility control, radio access network sharing, positioning, session management, etc. The CU(s) 103 control the operation of the Distributed Units (DUs) 105 over an interface (including F1-c and F1-u for the control plane and user plane, respectively).

In FIG. 1A, the C-RAN 100A includes a single CU 103, which handles control plane functions, user plane functions, some non-real-time functions, and/or Packet Data Convergence Protocol (PDCP) processing. The CU 103 (in the C-RAN 100A) may communicate with at least one wireless service provider's Next Generation Cores (NGC) 112 using 5G NGc and 5G NGu interfaces. The gNB may operate in Stand Alone mode or Non Stand Alone mode. In Non Stand Alone mode, the CU 103 communicates with at least one service provider's 4G core network. Other options for RAN to Core connectivity as defined 3GPP are also possible. In some 5G configurations (not shown in FIG. 1A), a CU 103 is split between a CU-CP that handles control plane functions and a CU-UP that handles user plane functions.

In some configurations, each DU 105 comprises a logical node hosting (performing processing for) Radio Link Control (RLC) and Media Access Control (MAC) layers, as well as optionally the upper or higher portion of the Physical (PHY) layer (where the PHY layer is split between the DU 105 and RU 106). In other words, the DUs 105 implement a subset of the gNB functions, depending on the functional split (between CU 103 and DU 105). In some configurations, the L3 processing (of the 5G air interface) may be implemented in the CU 103 and the L2 processing (of the 5G air interface) may be implemented in the DU 105. As noted above, a DU 105 (or a CU 103) may act as a “radio controller” for one or more RUs 106 in a 5G C-RAN 100A operating according to O-RAN specifications.

Each RU 106 comprises a logical node hosting the portion of the PHY layer not implemented in the DU 105 (that is, the lower portion of the PHY layer) as well as implementing the basic RF and antenna functions. In some 5G configurations, the RUs (RUs) 106 may communicate baseband signal data to the DUs 105 on an NG-iq interface. In some 5G configurations, the RUs 106 may implement at least some of the L1 and/or L2 processing. In some configurations, the RUs 106 may have multiple ETHERNET ports and can communicate with multiple switches.

Although the CU 103, DU 105, and RUs 106 are described as separate logical entities, one or more of them can be implemented together using shared physical hardware and/or software. For example, in the exemplary embodiment shown in FIG. 1A, for each cell 102, the CU 103 and DU 105 serving that cell 102 could be physically implemented together using shared hardware and/or software, whereas each RU 106 would be physically implemented using separate hardware and/or software. Alternatively, the CU(s) 103 may be remotely located from the DU(s) 105.

Each RU 106 includes or is coupled to one or more antennas (not shown) via which downlink RF signals are radiated to various items of user equipment (UE) and via which uplink RF signals transmitted by UEs 110 are received.

The CU 103 and/or DU(s) 105 may be coupled to a core network 112 of the associated wireless network operator over an appropriate back-haul network 116 (such as the Internet). Also, each DU 105 is communicatively coupled to the RUs 106 served by it using a front-haul network 118. Each of the DU(s) 105 and RUs 106 include one or more network interfaces (not shown) to enable the DU(s) 105 and RUs 106 to communicate over the front-haul network 118.

In one implementation, the front-haul 118 that communicatively couples the DU(s) 105 to the RUs 106 is implemented using a switched ETHERNET network 121. In such an implementation, each DU 105 and RU 106 includes one or more ETHERNET interfaces for communicating over the switched ETHERNET network 121 used for the front-haul 118. However, it is to be understood that the front-haul 118 between each DU 105 and the RUs 106 served by it can be implemented in other ways.

Each CU 103, DU 105, and RU 106, (and the functionality described as being included therein), as well as any other device in the system 101A more generally, and any of the specific features described here as being implemented by any of the foregoing, can be implemented in hardware, software, or combinations of hardware and software, and the various implementations (whether hardware, software, or combinations of hardware and software) can also be referred to generally as “circuitry” or a “circuit” or “circuits” configured to implement at least some of the associated functionality. When implemented in software, such software can be implemented in software or firmware executing on one or more suitable programmable processors or configuring a programmable device (for example, processors or devices included in or used to implement special-purpose hardware, general-purpose hardware, and/or a virtual platform). Such hardware or software (or portions thereof) can be implemented in other ways (for example, in an application specific integrated circuit (ASIC), etc.). Also, the RF functionality can be implemented using one or more RF integrated circuits (RFICs) and/or discrete components. Each CU 103, DU 105, RU 106, and the system 101A more generally, can be implemented in other ways.

As noted above, in the exemplary configuration described here in connection with FIG. 1A, the C-RAN 100A is implemented as a 5G NR RAN that supports a 5G NR wireless interface to wirelessly communicate with the UEs 110.

More specifically, in the exemplary embodiment described here in connection with FIG. 1A, the 5G NR wireless interface may support the use of beamforming for wirelessly communicating with the UEs 110 in both the downlink and uplink directions using the millimeter wave (mmWave) radio frequency (RF) range defined for 5G NR (Frequency Range 2 or “FR2”), e.g., ranging from 24 GHz to 40 or 100 GHz. 5G NR RAN systems typically make use of fine beams and beamforming, especially when FR2 is used. To perform such beamforming, each RU 106 comprises an array of multiple, spatially separated antennas. When FR2 is used, the spacing of the antennas in the array is on the order of several millimeters (as opposed to several centimeters as is the case when FR1 is used) and can be implemented in a convenient fashion.

When a UE 110 attaches to the communication system 101, its Random Access Channel (RACH) and Sounding Reference Signal (SRS) signals may be processed by all the RUs 106. The RUs 106 near the UE 110 receive the signals with good strength, while other RUs receive the signals with poor strength. The DU 105 and/or CU 103 may determine the relative location of a UE 110 by ranking the signal strength of the wireless device's signal(s) across all RUs 106 and picking the top RUs 106 (e.g., the top three or four RUs 106) to be anchor RUs 106 for the UE 110, collectively referred to as a combining zone. These RUs 106 in the combining zone may be indicated in a vector called a combining zone vector (CZV) for further processing. For example, a different CZV may be stored for each UE 110, which indicates the RUs 106 in a combining zone that transmit to and/or receive from (e.g., “communicating with”) the respective UE 110.

In other words, a minimum combining zone may be represented by a CZV and may include a subset of RUs 106 in the communication system that are used to communicate with a particular UE 110, e.g., each UE 110 may have a minimum combining zone that may or may not overlap with a minimum combining zone for another UE 110. A quantized signature vector (QSV) for a UE 110 may be a vector that includes an element for each RU 106, where each element has one of a finite set of values. For example, the element for an RU 106 may have a first value (for example, a value of “1”) if the RU 106 is included in the simulcast zone for that UE 110 and may have a second value (for example, a value of “0”) if the RU 106 is not included in the simulcast zone for that UE 110. The CZV may be a subset of the QSV. In some configurations, two UEs 110 may be in frequency reuse (e.g., two UEs 110 use the same frequency resources) only if their CZVs are mutually orthogonal.

A UE's 110 CZV may be determined/updated throughout a UE's 110 session, even if the UE 110 moves across different RUs 106 in the communication system 101. This process may be referred to as location information tracking and may be performed by at least the L2 layer of the baseband controller 104 in the communication system 101.

In some configurations, the C-RAN 100A may implement uplink combining in which a UE's combining zone of RUs 106 (e.g., up to four) receive RF signals from a particular UE 110 and a DU 105 and/or CU 103 combines them (e.g., using a maximum likelihood ratio combining) into a single uplink signal. Additionally or alternatively, the C-RAN 100A may implement downlink combining in which a group of RUs 106 send downlink RF signals to a particular UE 110, which combines them (e.g., using a maximum likelihood ratio combining) into a single downlink signal.

A management system 114 may be communicatively coupled to the CU(s) 103, DU(s) 105, and/or RUs 106, for example, via the back-haul network 116 and/or the front-haul network 118. The management system 114 may assist in managing and/or configuring the C-RAN 100A. A hierarchical architecture can be used for management-plane (“M-plane”) communications. When a hierarchical architecture is used, the management system 114 can send and receive M-plane (management) communications to and from the DU 105, which in turn forwards relevant M-plane communications to and from the RUs 106 as needed. Alternatively, a direct architecture can also be used for M-plane communications. When a direct architecture is used, the management system 114 can communicate directly with the RUs 106 (without having the M-plane communications forwarded by the CU 103 or DU 105). A hybrid architecture can also be used in which some M-plane communications are communicated using a hierarchical architecture and some M-plane communications are communicated using a direct architecture. Proprietary protocols and interfaces can be used for such M-plane communications. Also, protocols and interfaces that are specified by standards such as O-RAN can be used for such M-plane communications.

### Example 4G C-RAN

FIG. 1B is a block diagram illustrating another exemplary configuration of an Evolved Node B 100B (also referred to here as an “eNodeB” or “eNB”) implemented using a C-RAN that employs at least one baseband unit 104 and one or more radio units 106. The eNodeB 100B may provide wireless service using the Long Term Evolution (LTE) air interface.

LTE is a standard developed by the 3GPP standards organization. In this configuration, the baseband controller 104 and RUs 106 together are used to implement an eNodeB 100B. An eNB 100B may be used to provide UEs 110 with mobile access to the wireless network operator's core network 112 to enable UEs 110 to wirelessly communicate data and voice (using, for example, Voice over LTE (VoLTE) technology). However, it should be noted that the present systems and methods may be used with other wireless protocols, e.g., the systems 100A-B (and their associated functionality) may be implemented in a 3GPP 5G RAN (using a 5G air interface) and/or a 3GPP 4G RAN (using a 4G air interface).

The RUs 106 may be deployed at a site to provide wireless coverage and capacity for one or more wireless network operators. The site may be, for example, a building or campus or other grouping of buildings (used, for example, by one or more businesses, governments, other enterprise entities) or some other public venue (such as a hotel, resort, amusement park, hospital, shopping center, airport, university campus, arena, or an outdoor area such as a ski area, stadium, or a densely-populated downtown area). In some configurations, the site is at least partially (and optionally entirely) indoors, but other alternatives are possible.

The C-RAN 100B may include a baseband unit 104, which may also be referred to as “baseband controller” 104, or just “controller” 104. Each radio unit (RU) 106 may include or be coupled to at least one antenna used to radiate downlink RF signals to user equipment (UEs) 110 and receive uplink RF signals transmitted by UEs 110. The baseband controller 104 may optionally be physically located remotely from the site, e.g., in a centralized bank of baseband controllers 104. Additionally, the RUs 106 may be physically separated from each other within the site, although they are each communicatively coupled to the baseband controller 104 via a front-haul network 118 (or just “front-haul”). Communication relating to L1 functions generally relies on the front-haul network 118 interface. As before, every RU 106 in the system 100B may transmit the same or different cell-ID for each of the cell(s) 102 they all serve, depending on the number of carriers and frequency reuse layers. As noted above, a baseband controller 104 may be referred to as a “radio controller” for one or more RUs 106 in a 4G C-RAN 100B operating according to O-RAN specifications.

Each UE 110 may be a computing device with at least one processor that executes instructions stored in memory, e.g., a mobile phone, tablet computer, mobile media device, mobile gaming device, laptop computer, vehicle-based computer, a desktop computer, etc. Each baseband controller 104 and RU 106 may be a computing device with at least one processor that executes instructions stored in memory. Furthermore, each RU 106 may optionally implement one or more RU instances, e.g., a processing core that executes instructions that implement the functionality of an RU 106.

The C-RAN 100B may optionally implement frequency reuse where the same frequency resource(s) are used for multiple sets of UEs 110, each set of UEs 110 being under a different, geographically diverse set of RUs 106, e.g., all operating in the same cell 102 or cells 102. For example, all of the RUs 106 may broadcast the same Cell-ID (or Cell-IDs).

The system 100B is coupled to a core network 112 of each wireless network operator over an appropriate back-haul network 116. For example, the Internet may be used for back-haul 116 between the system 100B and each core network 112. However, it is understood that the back-haul network 116 can be implemented in other ways. Communication relating to L3 functions generally relies on the back-haul network 116 interface. Each of the back-haul network 116 and/or the front-haul network 118 described herein may be implemented with one or more network elements, such as switches, routers, and/or other networking devices. For example, the back-haul network 116 and/or the front-haul network 118 may be implemented as a switched ETHERNET network.

Also, in an exemplary LTE configuration, each core network 112 may be implemented as an Evolved Packet Core (EPC) 112 comprising standard LTE EPC network devices such as, for example, a mobility management entity (MME) and a Serving Gateway (SGW) and, optionally, a Home eNB gateway (HeNB GW) (not shown) and a Security Gateway (SeGW or SecGW) (not shown).

Moreover, in an exemplary LTE configuration, each baseband controller 104 may communicate with the MME and SGW in the EPC core network 112 using the LTE S1 interface and communicates with eNBs using the LTE X2 interface. For example, the baseband controller 104 can communicate with an outdoor macro eNB (not shown) via the LTE X2 interface.

Each baseband controller 104 and radio unit 106 can be implemented so as to use an air interface that supports one or more of frequency-division duplexing (FDD) and/or time-division duplexing (TDD). Also, the baseband controller 104 and the radio units 106 can be implemented to use an air interface that supports one or more of the multiple-input-multiple-output (MIMO), single-input-single-output (SISO), single-input-multiple-output (SIMO), and/or beam forming schemes. For example, the baseband controller 104 and the radio units 106 can implement one or more of the LTE transmission modes. Moreover, the baseband controller 104 and the radio units 106 can be configured to support multiple air interfaces and/or to support multiple wireless operators.

In some configurations, in-phase, quadrature-phase (I/Q) data representing pre-processed baseband symbols for the air interface is communicated between the baseband controller 104 and the RUs 106. Communicating such baseband I/Q data typically requires a relatively high data rate front haul.

In some configurations, a baseband signal can be pre-processed at a source RU 106 and converted to frequency domain signals (after removing guard band/cyclic prefix data, etc.) in order to effectively manage the front-haul rates, before being sent to the baseband controller 104. Each RU 106 can further reduce the data rates by quantizing such frequency domain signals and reducing the number of bits used to carry such signals and sending the data. In a further simplification, certain symbol data/channel data may be fully processed in the source RU 106 itself and only the resultant information is passed to the baseband controller 104.

The Third Generation Partnership Project (3GPP) has adopted a layered model for the LTE radio access interface. Generally, some combination of the baseband controller 104 and RUs 106 perform analog radio frequency (RF) functions for the air interface as well as digital Layer 1 (L1), Layer 2 (L2), and Layer 3 (L3) (of the 3GPP-defined LTE radio access interface protocol) functions for the air interface. Any suitable split of L1-L3 processing (between the baseband controller 104 and RUs 106) may be implemented. Where baseband signal I/Q data is front hauled between the baseband controller 104 and the RUs 106, each baseband controller 104 can be configured to perform all or some of the digital L1, L2, and L3 processing for the air interface. In this case, the L1 functions in each RU 106 is configured to implement all or some of the digital L1 processing for the air interface.

Where a front-haul ETHERNET network 118 is not able to deliver the data rate need to front haul (uncompressed) I/Q data, the I/Q data can be compressed prior to being communicated over the ETHERNET network 118, thereby reducing the data rate needed communicate such I/Q data over the ETHERNET network 118.

Data can be front-hauled between the baseband controller 104 and RUs 106 in other ways, for example, using front-haul interfaces and techniques specified in the Common Public Radio Interface (CPRI) and/or Open Base Station Architecture Initiative (OBSAI) family of specifications. The baseband controller 104 described herein may be similar to and/or perform at least some of the functionality of the O-RAN Distributed Unit (O-DU).

Where functionality of a 5G DU 105 is discussed herein, it may equally apply to a 5G CU 103 or a 4G baseband controller 104. Where functionality of a 5G CU 103 is discussed herein, it may equally apply to a 5G DU 105 or a 4G baseband controller 104. Where functionality of a 4G baseband controller 104 is discussed herein, it may equally apply to a 5G DU 105 or a 5G CU 103. Therefore, where a C-RAN 100A-B is described herein, it may include 5G elements (as in FIG. 1A) and/or 4G elements (as in FIG. 1B).

### Challenges to DL/UL Reuse

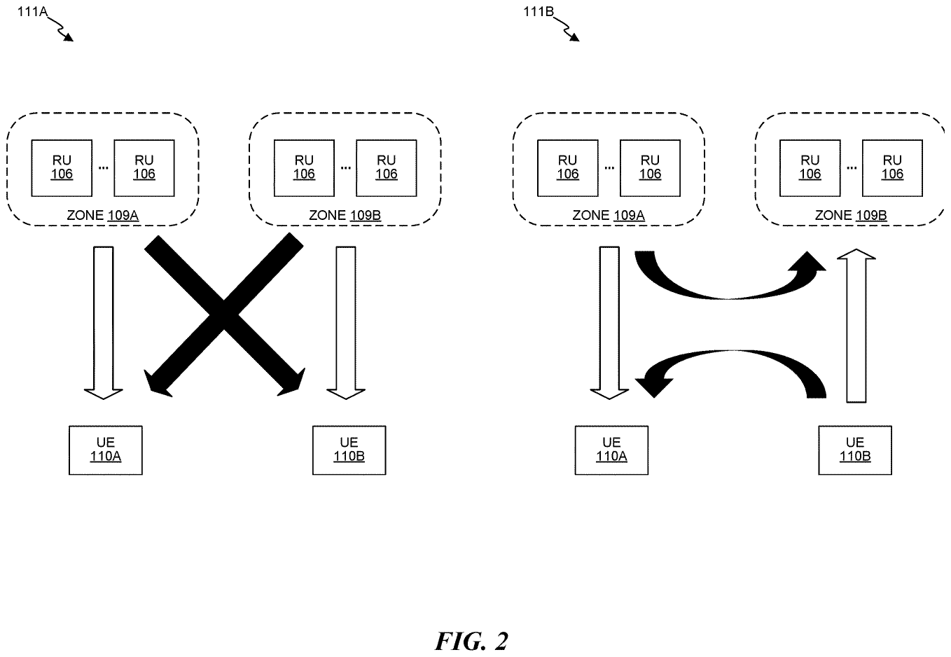

FIG. 2 is a block diagram illustrating a downlink (DL) reuse scenario 111A (on the left of FIG. 2) and a downlink/uplink (DL/UL) reuse scenario 111B (on the right of FIG. 2). In FIG. 2, the solid arrows represent unwanted interference (e.g., forming an X in the DL reuse scenario 111A) and the unfilled arrows represent desired signals between RUs 106 and UEs 110. Specifically, the left portion of FIG. 2 illustrates conventional DL reuse in which RUs are grouped into separate zones 109 (e.g., where all RUs 106 in a particular zone 109 communicate with a given UE 110) such that the interference from RUs of one zone 109 to the UE(s) 110 of a second zone 109 are negligible. UL transmissions from UE(s) 110 (SRS and/or RACH) may be measured to estimate the interference. As long as the RUs 106 in a first zone 109A don't interfere with the second UE 110B and the RUs 106 in a second zone 109B don't interfere with the first UE 110A, the first UE 110A and the second UE 110B can be in downlink reuse on the same frequency on the same slot.

In the present systems and methods, RUs 106 in the first zone 109A serve the first UE 110A on the downlink on the same frequency and timeslot that RUs 106 in the second zone 109B serve the second UE 1101B on the uplink. Cross interference is one risk when implementing DL/UL reuse, e.g., the first UE 110A receives interference from the second UE 110B and/or the RUs 106 in the second zone 109B receive interference from the RUs 106 in the first zone 109A. A further complication is that a communication system 100 may not be able to estimate the interference (and thus reuse zones) via UE 110 UL measurements. UE 110 mobilities can further complicate interference measurements.

Thus, interference between candidate UEs 110 (e.g., UEs 110 that are candidate for DL/UL reuse) may be measured by: (1) configuring UL candidate UEs 110 to transmit SRS in a certain RB resources; (2) configuring DL UE candidate UEs 110 to measure interference on RBs and symbols used to transmit the SRS and to send channel state information measurement (CSI report); and (3) no UEs 110 will be configured for DL traffic on these SRS resources.

For example, UEs 110 may report channel state information including the estimated channel quality indicator (CQI), pre-coding matrix indicator (PMI), rank indicator (RI), and/or layer indicator (LI) which are based on SINR measurements. In case of DL-UL reuse, for the UE 110 to receive on DL, in addition to DL interference from neighbor cells, there are interferences from UEs 110 transmitting on same time/frequency. Therefore the present systems and methods proposes that the UL candidate UE 110 send SRS, and the DL candidate UEs 110 measure the total interference (from neighbor as well as UL candidates) on the RBs/symbols occupied by the SRS signal.

The benefit of doing UL and DL reuse on the same time-frequency resource is that there are more downlink transmission slots than uplink slots, an uplink-heavy UE 110 can be configured with more UL slots without changing the overall UL/DL ratio of slots. It should be noted that RUs 106 in a particular zone may, and likely would, serve more than one UE 110. Similarly, a zone 109 may include more than two RUs 106.

### Cross-RU Interference

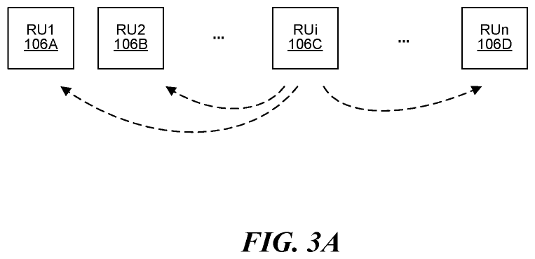

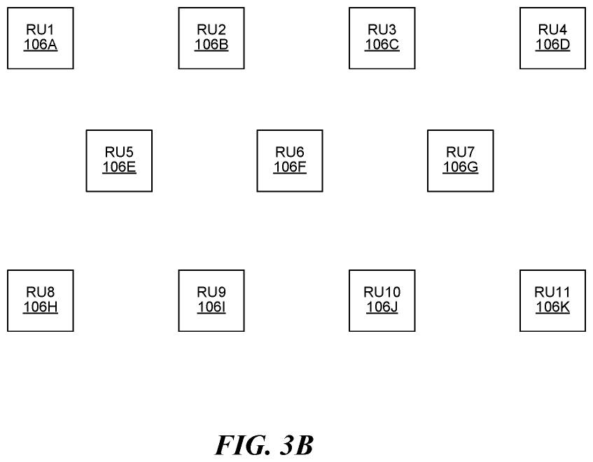

FIG. 3A is a block diagram illustrating cross-RU interference measurement. As noted above, the RUs 106 are deployed in different physical locations within a site, e.g., in different positions on a floor of an office building. Cross-RU interference occurs where RUs 106 in the second zone 109B receive interference from the RUs 106 in the first zone 109A. For each RU 106, interference from the respective RU 106 is measured at each other RU 106 (e.g., when transmitting a synchronization signal, such as CSI-RS). Since RUs 106 may be statically installed, this inter-RU interference may be measured once during installation and tabulated.

RU zones 109 for DL/UL reuse can be determined based on the recorded measurements. Specifically, if the interference at a particular RU 106 is lower than a cross-RU interference threshold then the interference can be ignored because it would not prevent desired uplink signals from UEs 110 from being received at the RUs 106. Thus, at the end of the measurement process, a list has been compiled that indicates, for each RU 106, which other RU(s) 106 will have problematic interference and which will not be problematic. Then the gNB can determine two UEs 110 served by respective groups of RUs 106 with low cross-RU measurements that are candidates for DL/UL reuse.

Thus, for each RUi (i={1 . . . n}): (1) schedule RUi to transmit a known signal (e.g., CSI-RS); (2) schedule RUj (j={1 . . . n} and J≠i) to measure the received power; and (3) for each RUi, tabulate all RUj with receive power less than a cross-RU interference threshold. The group of RUj is then the list of RUs that may participate in DL/UL reuse with RUi.

FIG. 3B is a block diagram illustrating possible cross-RU interference between a plurality of RUs 106A-K in an example system. Specifically, Table 1 illustrates which RUs 106 in FIG. 3B might have a cross-RU interference less than a cross-RU interference threshold:

TABLE 1

| RUᵢ | RUs with cross-RU interference less than a threshold |
|---|---|
| 1 | 3, 4, 6, 7, 9, 10, 11 |
| 2 | 4, 8, 10, 11 |
| 3 | 1, 5, 8, 9, 11 |
| 4 | 1, 2, 5, 6, 8, 9, 10 |
| 5 | 3, 4, 7, 10, 11 |
| 6 | 1, 4, 8, 11 |
| 7 | 1, 2, 5, 8 |
| 8 | 2, 3, 4, 6, 7, 10, 11 |
| 9 | 2, 3, 4, 6, 7, 11 |
| 10 | 1, 2, 4, 5, 8 |
| 11 | 1, 2, 3, 5, 6, 8, 9 |

### Cross-UE Interference

For an indoor 5G TDD C-RAN deployment, a particular slot may be dynamically reconfigured for use as a DL slot for some UE(s) 110 and as UL slot(s) for other UEs 110, which may (1) increase UL throughput for UL heavy UEs 110; and (2) achieve DL+UL reuse in same slot of a TDD channel. In this scenario, the physical uplink shared channel (PUSCH) becomes an additional source of interference for the UE 110 receiving the physical downlink shared channel (PDSCH). This cross-UE interference may be measured by (1) configuring some UEs 110 measure interference using CSI-IM resource(s) on certain symbols; and (2) configuring some UEs 110 to transmit SRS on the same CSI-IM resources.

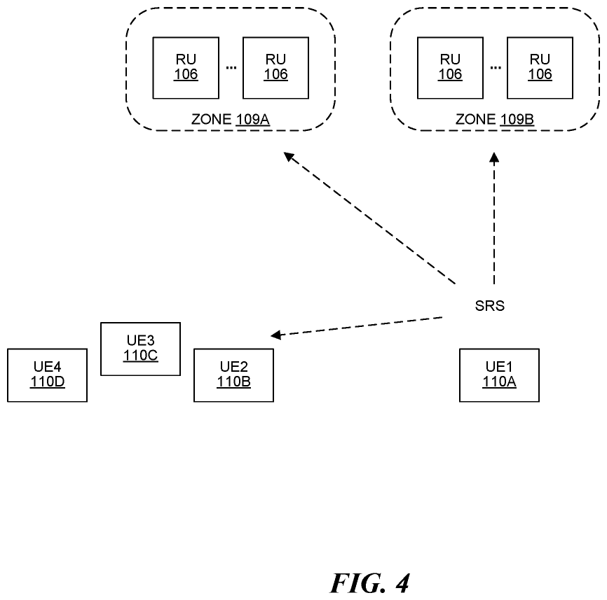

FIG. 4 is a block diagram illustrating cross-UE interference measurement. UE1 110A is configured to transmit an SRS on particular symbol(s), slot(s), and frequenc(ies). UE2 110B, UE3 110C, and UE4 110D are configured to measure interference on the same resource blocks (particular symbol(s), slot(s), and frequenc(ies)) that UE1 110A is transmitting the SRS. UE2 110B, UE3 110C, and UE4 110D are configured to not transmit or receive during those particular symbol(s) and slot(s).

A similar measurement process can be performed wherein UE2 1101B, UE3 110C, and UE4 110D are configured to transmit SRS on particular symbol(s), slot(s), and frequenc(ies), and UE1 110A is configured to measure interference on the same resource blocks (particular symbol(s), slot(s), and frequenc(ies)) that UE2 110B, UE3 110C, and UE4 110D are transmitting the SRS.

Reciprocity in measurements of cross-UE interference is not always necessary in the present systems and methods. For example, in some configurations, UE1 110A has a high demand for UL traffic and the scheduler wants to allocate more UL time slot and frequency resources to it. In this case, only the cross-UE measurement where UE2 110B, UE3 110C, and UE4 110D measure interference on the same resource blocks (particular symbol(s), slot(s), and frequenc(ies)) that UE1 110A is transmitting the SRS might be needed.

The cross-UE interference measurement process may be similar to the inter-cell measurement process, but here all the UEs 110 and RUs 106 are in the same cell 102. If UE2/UE3/UE4 are in UL/DL reuse with UE1, then UE2/UE3/UE4 can still be in DL reuse with each other if they're separated enough.

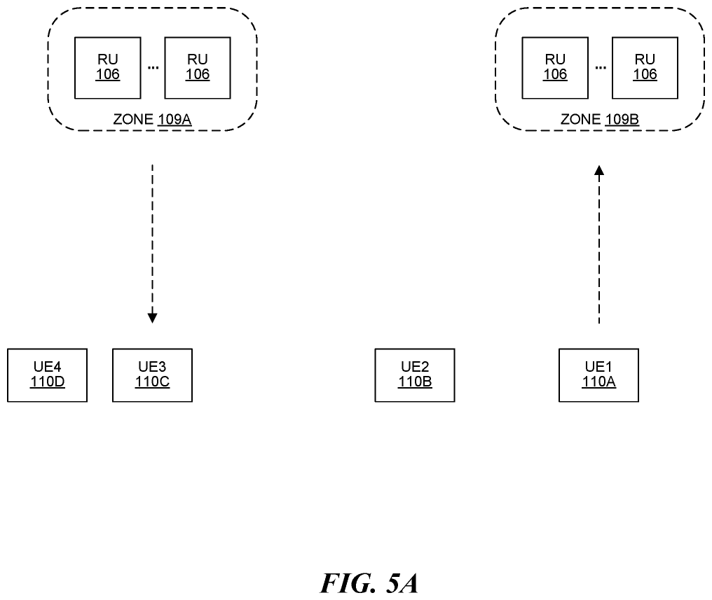

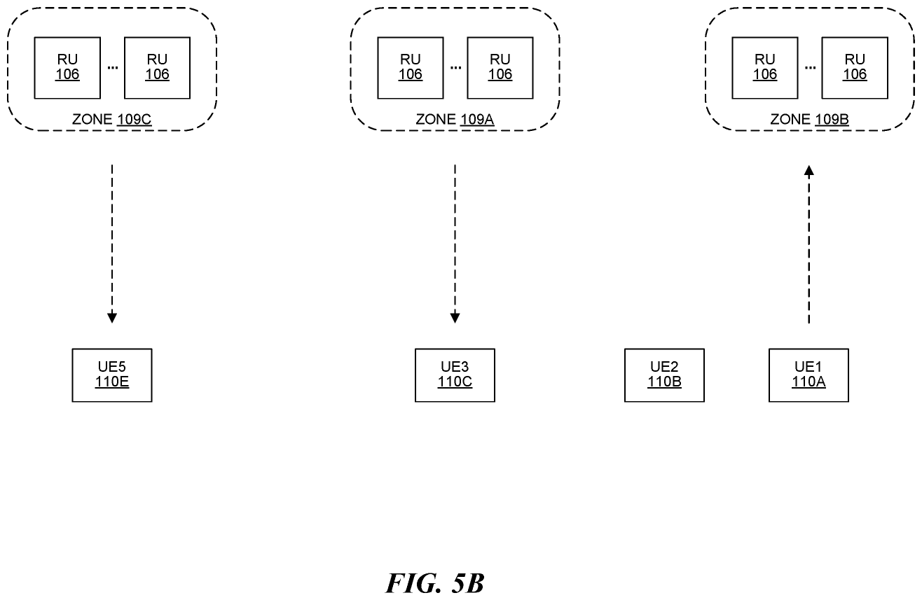

FIG. 5A is a block diagram illustrating a first DL/UL reuse configuration. In FIG. 5A, UE1 110A and UE3 110C are in DL/UL reuse (UE1 110A in UL and UE3 110C in DL), and UE2 110B and UE4 110D are not in reuse with UE1 110A and UE3 110C.

FIG. 5B is a block diagram illustrating a second DL/UL reuse configuration. It should be noted that multiple UEs 110 can be in downlink reuse and DL/UL reuse with another UE 110. For example, in FIG. 5B: (1) UE1 110A, UE3 110C and UE5 110E are in DL/UL reuse (UE1 110A in UL while UE3 110C and UE5 110E in DL); and (2) UE2 110B is not in reuse.

### CSI-IM, ZP-CSI, SRS

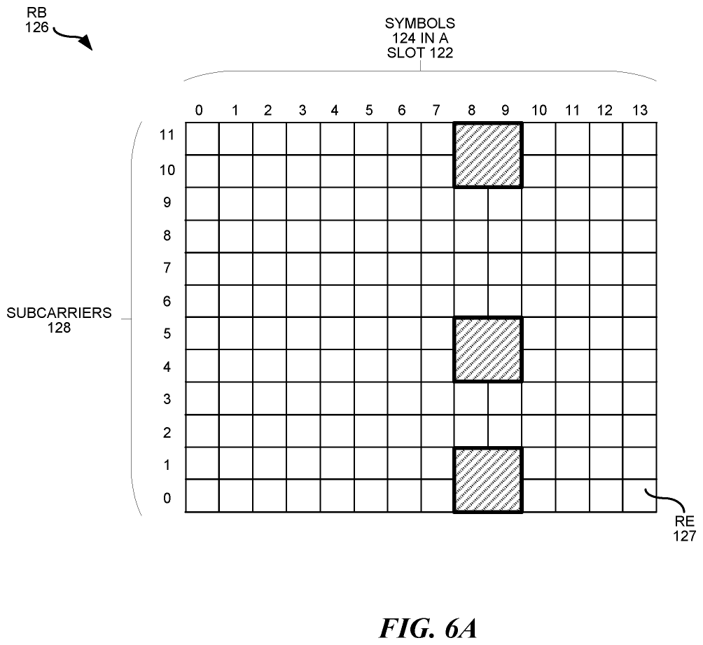

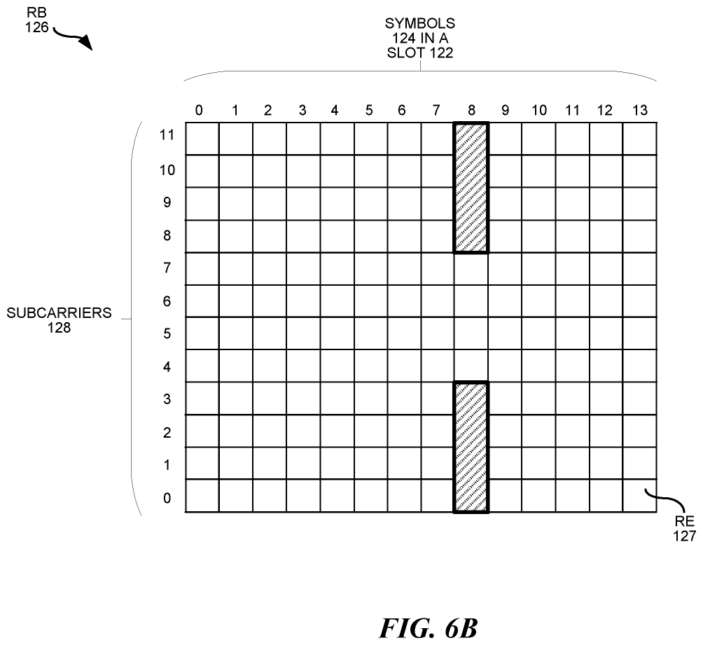

FIGS. 6A-B are block diagrams illustrating examples of where to measure the cross-UE interference within an RB 126. Each row in FIGS. 6A-B represent one subcarrier 128 in a physical resource block (PRB) 126. There are 12 subcarriers 128 shown in the example RB 126, however, other configurations are possible. Each column in FIGS. 6A-B represents one symbol 124 in a slot 122. There are 14 symbols 124 transmitted in the example resource block 226, however, other configurations are possible. Each square (one symbol 124×one subcarrier 128) in FIGS. 6A-B is a Resource Element (RE) 127. For example, the example RB 126 in FIGS. 6A-B include 168 REs 127, but other configurations are possible.

In 3GPP, operators are given some flexibility to configure CSI interference measurement (CSI-IM) resources. In other words, operators can specify which resources to measure interference on. A CSI-IM resource is a set of RE(s) 127 that fully overlap with a ZP CSI-RS and are used to measure interference at the UE. According to 3GPP definitions, CS-IM and ZP CSI-RS are two independent configurations. But for interference measurement it makes sense to overlap them.

There are two patterns (of four REs 127 each) that can be used for CSI-IM (and/or ZP-CSI-RS) resources: (1) four REs 127 in a 2 symbol×2 subcarrier contiguous block of REs 127 (pattern0) as illustrated in FIG. 6A; or (2) one symbol×four subcarrier contiguous block of REs 127 (pattern1) illustrated in FIG. 6B. By using different starting positions of the subcarriers in pattern0 (FIG. 6A), there can be up to six groupings for the same 2 symbols (12 subcarriers with 2 subcarriers in each grouping). In pattern1, up to three groupings for a slot (12 subcarriers with 4 subcarriers in each grouping). Thus, FIG. 6A illustrates how 3 CSI-IM pattern0 resources (and 3 row-5 ZP-CSI-RS resources in Table 7.4.1.5.3-1 in 3GPP TS 38.211 V17.3.0 (2022-09)) could possibly be configured in an RB 126, while FIG. 6B illustrates 2 CSI-IM pattern1 resources (and 2 row-4 ZP-CSI-RS resources in Table 7.4.1.5.3-1 in 3GPP TS 38.211 V17.3.0 (2022-09)) could possibly be configured. The starting RB 126, the starting symbol 124, and the number of RBs can be configured. A communication system 101 may use 4 antenna ports for TDD.

A zero power CSI reference signal (ZP-CSI-RS) indicates to the UE 110 there is no data being transmitted from the serving cell 102 on those resources. The symbols 124 and subcarriers 128 used for the ZP-CSI-RS may be given by Table 7.4.1.5.3-1 in 3GPP TS 38.211 V17.3.0 (2022-09), which is incorporated by reference herein. Each row in Table 7.4.1.5.3-1 represents a specific pattern, e.g., row 5 in Table 7.4.1.5.3-1 matches CSI-IM pattern0, and row 4 in Table 7.4.1.5.3-1 matches CSI-IM pattern1. If the CSI-IM resource is configured as pattern1 (4×1 grouping), row 4 in Table 7.4.1.5.3-1 to tell the UE 110 that there are no serving cell transmissions in a particular chunk of RBs (one symbol×four subcarriers).

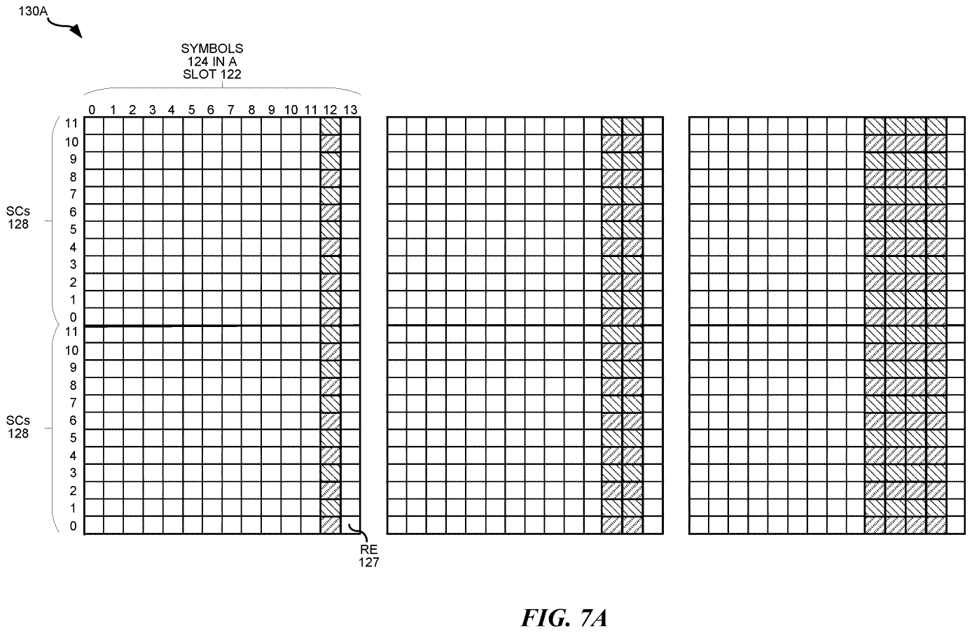

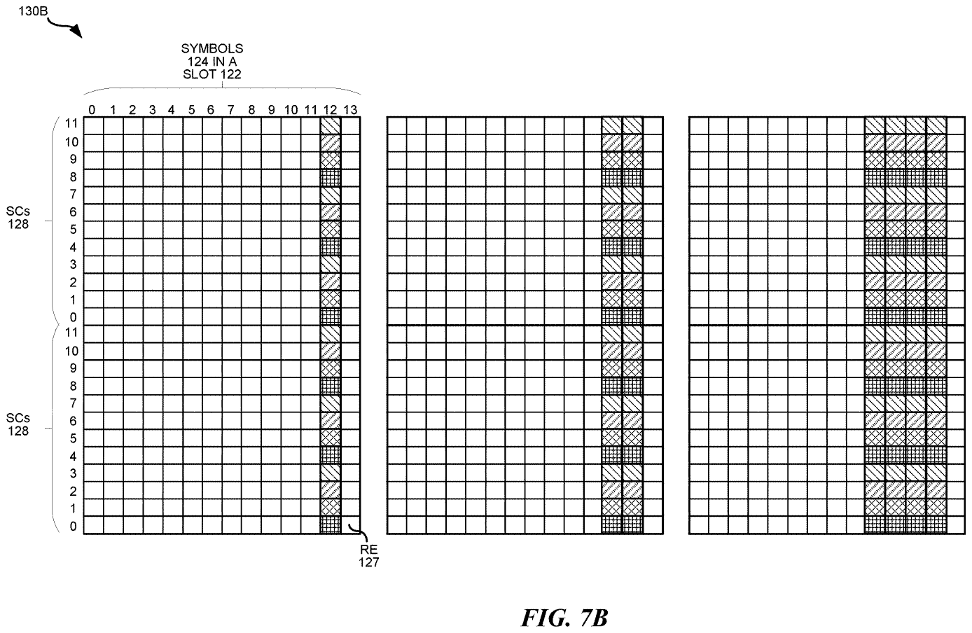

FIG. 7A is a block diagram illustrating possible comb2 configurations 130A for transmitting a Sounding Reference Signal (SRS). In 5G, the SRS could be transmitted on one, two, or four consecutive symbols 124. In comb2 configurations, the SRS is transmitted in every other subcarrier 128 of an RB 126 used for SRS. There are two comb offsets for comb2: 0,1. When a UE 110 is configured to use offset=0, it transmits SRS on subcarriers 0, 2, 4, . . . 10. When a UE 110 is configured to use offset=1, it transmits SRS on subcarrier 1, 3, 5, . . . 11. Up to 8 UEs can be multiplexed on same offset by using different cyclic shifts. In comb4 configurations, SRS is transmitted in every four subcarriers 128. There are 4 comb offsets: 0,1,2,3. Up to 12 UEs 110 can be configured to transmit SRS on same comb offset by using different cyclic shifts. SRS uses either comb2 or comb4 (not comb1).

The SRS can be transmitted in any of the last six symbols 124 of a slot 122 (symbol #8-#13). The starting RB 126, SRS bandwidth (in RBs 126), and SRS hopping bandwidth (in RBs 126) can be configured. The SRS hopping bandwidth occupies contiguous RBs 126. For example, for SRS periodicity=Tsrs ms, SRS BW=80 PRBs. A first configuration may be: 2 hops with hopping BW=40 RB; a second hopping configuration may be 4 hops with hopping BW=20RB. With the first hopping configuration, a UE 110 sends SRS on top, bottom 40PRBs at alternate SRS occasions (one occasion every Tsrs ms). With the second hopping configuration, the UE 110 sends SRS on 20PRB at each occasion, loops through the 80PRB in 4 SRS occasions.

In the comb2 configurations shown in FIG. 7A, multiple UEs 110 are transmitting SRS in the same symbol and both comb offsets are used (where each of the two different fill patterns in FIG. 7A correspond to a different SRS comb offsets). Thus, the need to configure 3 CSI-IM resources to blank all 12 subcarriers 128 in an RB 126.

FIG. 7B is a block diagram illustrating possible comb4 configurations 130B for transmitting a Sounding Reference Signal (SRS). A SRS using comb4 configurations occupy every 4 subcarriers 128, hence there are four comb offsets. SRS of up to 12 UEs 110 can be multiplexed on same offset by using different cyclic shifts. Different UEs 110 can be configured to use different comb offsets. In the comb4 configurations shown in FIG. 7B, multiple UEs 110 are transmitting SRS in the same symbol and all four offsets are used (where each of the four different fill patterns in FIG. 7B correspond to a different SRS comb offset). Thus the need to configure 3 CSI-IM resources to blank all 12 subcarriers 128 in an RB 126.

The CSI-IM resources and the ZP-CSI-RS are configured to cover the same symbols where the SRS is transmitted. This ensures that the interference in those symbols due to UL transmission from particular UEs 110 are measured (as part of cross-UE interference for DL/UL reuse).

### Cross-UE Interference Measurement Examples

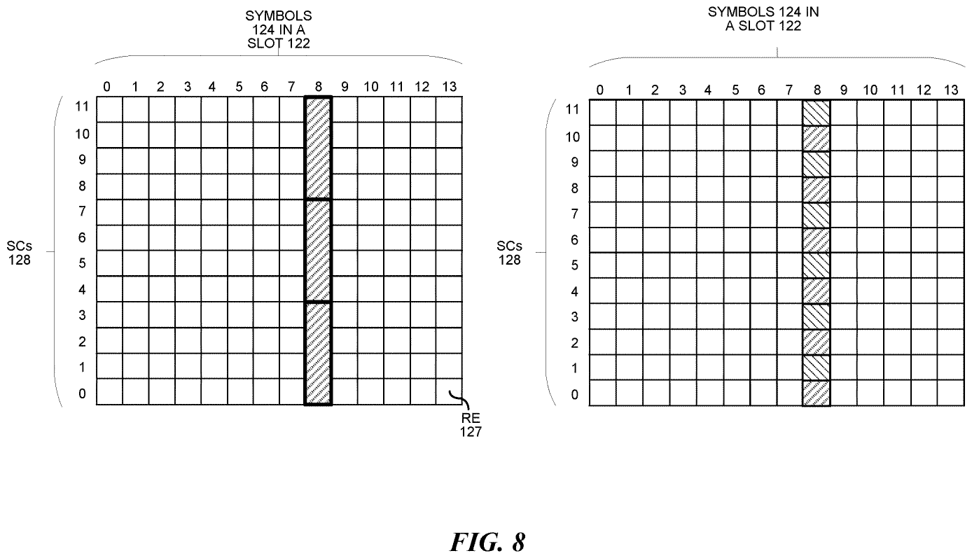

FIG. 8 is a block diagram illustrating CSI-IM, ZP-CSI-RS, and SRS configurations for the examples below. The TDD-UL-DL-ConfigDedicated reconfiguration is used to change slot patterns dynamically for selected UEs 110, since some UEs 110 may not support DCI2_0.

On the left side of FIG. 8, pattern1 is illustrated (e.g., similar to FIG. 6B but with 3 resources) in which 3 CSI-IM resources (with symbol location at symbol #8 and starting subcarrier locations at subcarriers #0, 4, and 8, respectively) for UEs 110 to measure the interference and the bandwidth is the entire frequency channel bandwidth (all RBs).

On the left side of FIG. 8, 3 row-5 ZP-CSI-RS resources (with symbol location at symbol #8, the starting subcarrier as ‘001’, ‘010’, ‘100’, respectively) are configured for UEs 110 to inform the UE that no DL data transmitted on these subcarriers of the entire frequency channel bandwidth (all RBs).

On the right side of FIG. 8, a comb2 configuration is used for transmitting a Sounding Reference Signal (SRS) on symbol #8. These are similar to the left portion of FIG. 7A in that the width used for the SRS is a single symbol 124. Using comb2 allows fewer UEs 110 to generate interference at one time. The SRS bandwidth shown in FIG. 8 is the largest allowed for SRS that is less than or equal to the channel bandwidth and may not use hopping. Four antenna ports are used for CSI-IM, ZP-CSI-RS, and SRS. It should be noted that FIG. 8 only shows the configurations in 1 PRB, however CSM-IM, AP-CSI-RS, SRS may be configured for full channel BW.

### Configuring Slots in Time Division Duplexing (TDD)

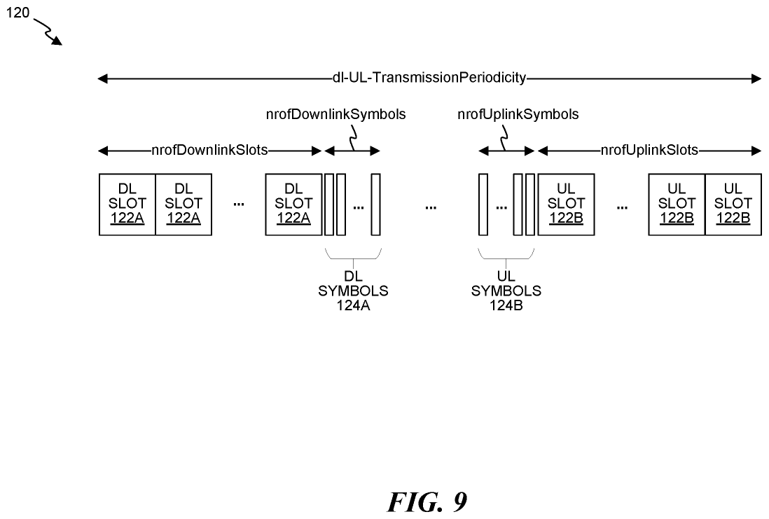

FIG. 9 is a block diagram illustrating a TDD pattern 120 that includes downlink slots (or symbols within slots), uplink slots (or symbols within slots), and optionally flexible slots (or symbols within slots). A flexible slot 122 is a slot 122 that the usage of its symbols 124 has not be specified yet.

TDD operates in a single carrier frequency (unlike FDD, which uses an uplink band paired with a downlink band), and each timeslot is used as either a downlink slot 122, an uplink slot 122, or a special slot 122. In some configurations of TDD, a repeating pattern 120 of 10 slots are used, e.g., where each group of 10 slots includes 8 downlink slots and 2 uplink slots. Other configurations of TDD use a repeating pattern 120 of 5 slots where each group of 5 slots includes 4 downlink slots and 1 uplink slot. The duration of a slot 122 is determined by the numerology (e.g., subcarrier spacing). When the numerology=1 (i.e. SCS=30 khz), the slot duration is 0.5 ms.

Special slots are used in a TDD system when switching from a DL slot 122 to an UL slot 122, e.g., a special slot 122 may include X DL symbols 124, Y guard symbols 124, and Z UL symbols 124, where X+Y+Z=14, x>=0, y>0, z>=0. If present, DL symbols 124 always are the leading symbols 124 of a special slot 122; UL symbols are always the ending symbols 124 of the special slot 122. The UE 110 will not transmit or receive on the special symbols 124 which are not defined, i.e. the undefined special symbols 124 are served as guard symbols 124.

In TDD, a TDD-UL-DL-ConfigCommon information element is broadcast to UEs 110 (as system information, such as System Information Block 1 (SIB1)) and is common to all UEs of a cell. This common configuration specifies one two patterns 120 in the common configuration: (1) the number of downlink slots 122A in the pattern 120; (2) the number of downlink symbols 124A in the pattern 120 (e.g., following the DL slots 122A); (3) the number of uplink symbols 124B in the pattern 120 (before the UL slots 122B; and (4) the number of uplink slots 122B in the pattern 120. Where a common configuration includes two patterns 120, the different patterns 120 do not need to include the same number of slots 122. All slots 122 and symbols 124 not specified in the TDD-UL-DL-ConfigCommon are considered flexible. UEs 110 know whether a slot 122 is configured as a downlink slot 122A or an uplink slot 122B implicitly from the PDSCH and PUSCH resource allocation.

One or more TDD-UL-DL-ConfigDedicated (dedicated configuration(s)) can optionally also be sent (through RRC re-configuration messages for a specific UE) that are specific to a certain UE 110. For example, whatever slots 122 and/or symbols 124 are not defined in the common configuration (and therefore classified as flexible) can be configured in the dedicated configuration. The dedicated configuration can only redefine flexible slots 122 and/or symbols 124 in the common configuration.

If there are still slots 122 and/or symbols 124 left as flexible after the dedicated configuration is applied, they can be redefined using DCI2, which is a UE 110 compatibility feature not shared by all UEs 110. Thus, not all UEs 110 will be able to use DCI2 to dynamically change the pattern 120. Accordingly, the present systems and methods use the common and dedicated configurations to change flexible slots/symbols to DL or UL but does not rely on DCI2 to configure flexible slots/symbols as UL or DL. The DCI2 can only redefine flexible slots 122 or symbols 124 in the dedicated configuration.

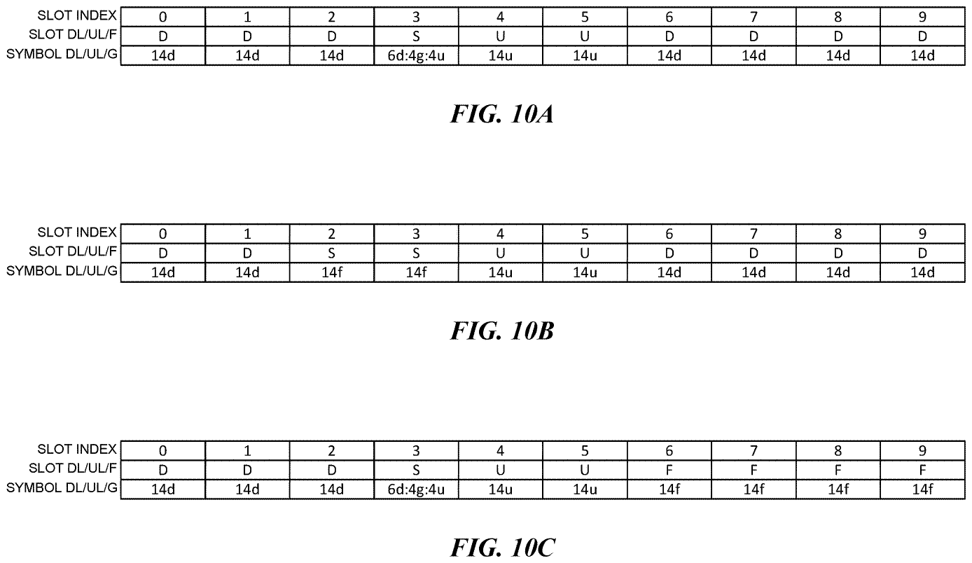

FIGS. 10A-C are exemplary 10-slot groupings that could be defined in a common configuration and used in TDD UL/DL reuse. The first row in each of FIGS. 10A-C is a slot index according to an air interface used by a wireless communication system 110A-B and UE(s) 110. The second row in each of FIGS. 10A-C indicates how each slot 122 is defined, e.g., downlink (DL), special (S), or uplink (UL). In other words, the second row indicates whether DL signals, UL, signals, or a combination of both are transmitted during the respective slot 122. The third row in each of FIGS. 10A-C indicates how the specific symbols 124 in each slot 122 are defined. In the examples of FIGS. 10A-C, each slot 122 carries 14 symbols 124. In a DL slot 122A, all 14 symbols 124 are downlink symbols 124A. In an UL slot 122B, all 14 symbols 124 carry uplink symbols 124B. In a special slot 122, a mix of DL symbols 124A and UL symbols 124B are defined, along with guard period symbols.

FIGS. 10B and 10C will be discussed with relation to Examples 1 and 2 below. It should be noted that the configuration illustrated in FIGS. 10A-C are merely exemplary and the present systems and methods are compatible with different amounts of slots 122 grouped together, different numbers of slots 122 per pattern 120, etc.

Each pattern 120 defined in a common configuration is constrained as follows: (1) any DL slots 122A and DL symbols 124A (if any) are configured in a contiguous block at the beginning of the pattern 120; and UL symbols 124B and UL slots 122B (if any) are configured a contiguous block at the end of the pattern 120; and flexible slots and symbols are any slots 122 and symbols in between the DL slots 122A/DL symbols 124A and the UL symbols 124B/UL slots 122B that are not defined in the common configuration as either DL or UL; and (2) in TDD when DL slots 122A (or DL symbols 124A within a DL slot 122A) switch to UL slots 122B (or UL symbols 124B within an UL slot 122B), a guard period is needed. However, a guard period is not necessary when switching from UL slots 122B to DL slots 122A. The guard period also is used to prevent (or limit) interference between downlink transmissions (e.g., delayed from propagation) and uplink transmissions.

Given the constraints above, the 10-slot grouping in FIG. 10A would require two patterns 120 to be configured in a common configuration for the UEs served by a system 101A-B: a first 6-slot pattern 120 with 3 DL slots, followed by 1 Special slot, followed by 2 UL slots; and a second 4-slot pattern 120 with four DL slots, no Special slots, and no UL slots. Thus, in FIG. 10A, all slots 122 and symbols 124 are fixed either as DL or UL, except for symbol #6-#9 of slot #3 (where slot #0 is the first slot 122 in a pattern 120, and symbol #0 is the first symbol 124 in a slot 122), which would be categorized as flexible symbols 124 and used for guard symbols 124.

For example, the TDD-UL-DL-ConfigCommon information element associated with FIG. 10A broadcast to UEs 110 (as system information, such as System Information Block 1 (SIB1)) may have the following information in it:
TDD-UL-DL-ConfigCommon
{referenceSubcarrierSpacing=kHz30
pattern1={dl-UL-TransmissionPeriodicity=2.5 ms
   nrofDownlinkSlots=3
   nrofDownlinkSymbols=6
   nrofUplinkSlots=2
   nrofUplinkSymbols=4
   dl-UL-TransmissionPeriodicity-v1530=3 ms}
pattern2={dl-UL-TransmissionPeriodicity=2 ms
   nrofDownlinkSlots=4
   nrofDownlinkSymbols=0
   nrofUplinkSlots=0
   nrofUplinkSymbols=0}

### Examples of Configuring TDD-UL-DL Patterns & CSI-IM, ZP-CSI-RS and SRS for TDD DL/UL Reuse

FIGS. 10B and 10C illustrate how TDD-UL-DL pattern(s) 120, CSI-IM, ZP-CSI-RS and SRS can be configured for interference measurement and DL+UL transmissions in same slot (and RB) of a TDD channel. First, interference measurement slots are configured, then the slots are configured again to be used in DL/UL reuse.

The Examples use TDD 4:2:4 (slots configured as DDDSUUDDDD) here, but the concept is applicable for other TDD ratios. Example 1 (Ex-1) uses slot #3 for interference measurement and DL+UL transmission. Example-2 (Ex-2) uses slot #6 for interference measurement and DL+UL transmission. Ex-2 may be advantageous since it requires lesser RRC signaling, and no change to the special slot 122.

At a high level, where DL+UL transmissions are desired in the same slot 122, the slot is configured as flexible in the TDD-UL-DL-ConfigCommon. Then, the TDD-UL-DL-ConfigDedicated can be used to re-configure these flexible slots 122 to serve different purposes. Initially all UEs 110 are configured with a TDD-UL-DL-ConfigDedicated; together with TDD-UL-DL-ConfigCommon, the end TDD pattern is the same as the original format.

When configuring UL interference measurement on DL in slot #m-sym #n: (1) for UEs 110 designated to measure the interference, re-configure TDD-UL-DL-ConfigDedicated (if needed) such that slot #m-sym #n is a DL symbol; and (2) for UEs 110 designated to generate the interference, re-configure TDD-UL-DL-ConfigDedicated such that slot #m-sym #n is a UL symbol.

When measuring cross-UE interference: (1) for UEs 110 designated to measure the interference, configure CSM-IM, ZP-CSI-RS for slot #m-sym #n; and (2) for the UE 110 designated to generate the interference (e.g., an UE 110 with high UL demand that needs a higher than normal UL allocation of resources), trigger SRS on slot #m-sym #n.

After the interference measurement is completed: (1) for UEs 110 designated to receive PDSCH on in slot #m, re-configure TDD-UL-DL-ConfigDedicated (if needed) so that slot #m is a DL or a special slot); and (2) for UEs 110 designated to transmit PUSCH in slot #m, re-configure TDD-UL-DL-ConfigDedicated so that slot #m is a UL slot.

In addition to existing periodic SRS for single value (SV) maintenance, a semi-persistent SRS may be configured for all UEs 110. The semi-persistent SRS is activated/deactivated via medium access control (MAC) for the UEs 110 to generate the UL interference.

It should be noted that instead of using TDD-UL-DL-ConfigDedicated, DCI0/1 may be used to implicitly indicate the new format for an individual slot 122. This is limited in that it's impossible to use the start and length indicator (SLIV) of DCI0/1 to describe a slot 122 using all three types of symbols 124: DL, guard/flexible, and UL.

### Example 1

In Example 1 (illustrated in FIG. 10B), the TDD-UL-DL-ConfigCommon is configured to keep slot #2, 3 as flexible slots. For example, the TDD-UL-DL-ConfigCommon information element associated with FIG. 10B broadcast to UEs 110 (as system information, such as System Information Block 1 (SIB1)) may have the following information in it:
TDD-UL-DL-ConfigCommon
{referenceSubcarrierSpacing=kHz30
pattern1={dl-UL-TransmissionPeriodicity=2.5 ms
   nrofDownlinkSlots=2
   nrofDownlinkSymbols=0
   nrofUplinkSlots=2
   nrofUplinkSymbols=0
   dl-UL-TransmissionPeriodicity-v1530=3 ms}
pattern2={dl-UL-TransmissionPeriodicity=2 ms
   nrofDownlinkSlots=4
   nrofDownlinkSymbols=0
   nrofUplinkSlots=0
   nrofUplinkSymbols=0}

When a connection is set up, the UE 110 is configured with TDD-UL-DL-ConfigDedicated which defines slot #2 as DL, slot #3 as a special slot 122 with format 6d:4g:4u. Combined with the above TDD-UL-DL-ConfigCommon, the same overall pattern of FIG. 10A is achieved. Additionally, a semi-persistent SRS with 10 ms periodicity are configured for all UEs 110. For example, the TDD-UL-DL-ConfigDedicated information element associated with FIG. 10B broadcast to UEs 110 may have the following information in it:
TDD-UL-DL-ConfigDedicated
{slotSpecificConfigurationsToAddModList
   {slotIndex 2
      symbols {allDownlink}
   }
   {slotIndex 3
      Symbols {explicit
{nrofDownlinkSymbols=6
   nrofUplinkSymbols=4}
      }
}
}

In Example 1, slot #3-sym #8 are used for interference measurement. Symbol #8 is the earliest symbol in a slot that can be used by SRS. Hence, the semi-persistent SRS is configured as:
nrofSRS-Ports=4,
resourceMapping={startPosition=5 (i.e., symbol #8), nrofSymbols=1}
freqDomainShift=0 (i.e., startRB=0)
freqHopping uses the largest SRS BW<=channel BW, no hopping
periodicityAndOffset=sl10 (3).

With reference to Example 1 as illustrated in FIG. 10B, the TDD-UL-DL-ConfigCommon configures slot #2 (from DL in the common configuration of FIG. 10A) to a Flexible slot 122 and slot #3 (from a special slot with format 6d:4g:4u in the common configuration of FIG. 10A) to having 14 flexible symbols 124. Assume criteria are developed to select UEs (Set1-UE) to monitor interference in slot #3, and to select UEs (Set2-UE) to generate interference in slot #3. The TDD-UL-DL-ConfigDedicated can be reconfigured for Set1-UE such that slot #3-sym #8 is a DL symbol (9d:4g:1u). Alternatively, the TDD-UL-DL-ConfigDedicated for Set2-UE could be configured such that slot #3-sym #8 is a UL symbol (4d:4g:6u. Thus, while the slot #3 is special in both FIGS. 10A and 10B, the specific symbol 124 configuration within slot #3 can be reconfigured using the TDD-UL-DL-ConfigDedicated.

Still with reference to Example 1 in FIG. 10B, 3 CSI-IM, 3 ZP-CSI-RS resources can be configured for Set1-UE (interference measuring UE 110). For example, CSI-IM-Resources can be configured as follows: Pattem, symbolLocation-p1=8, subcarrierLocation-p1=s0, s4, s8 respectively. The ZP-CSI-RS can be configured as follows: firstOFDMSymbolInTimeDomain=8 with row4=001, 010, 100 respectively. Both CSI-IM and ZP-CSI-RS can be configured to use nrofPorts=4, freqBand=full channel BW. Both CSI-IM and ZP-CSI-RS can be configured with a periodicity of 10 ms. Thus, the TDD-UL-DL-ConfigDedicated for the Set1-UE (to configure for monitoring CSI-IM on slot #3-symb #8) might include the following information:
TDD-UL-DL-ConfigDedicated
{slotSpecificConfigurationsToAddModList
   {slotIndex 2
      symbols {allDownlink}
   }
   {slotIndex 3
      Symbols {explicit
{nrofDownlinkSymbols=9
   nrofUplinkSymbols=1}
      }
}
}

Then, semi-persistent SRS can be used for Set2-UE (interference generating UE 110) and CQI measurements can be configured for Set1-UE (interference measuring UE 110). And the TDD-UL-DL-ConfigDedicated for the Set2-UE (interference generating UE 110) might include the following information:
TDD-UL-DL-ConfigDedicated
{slotSpecificConfigurationsToAddModList
   {slotIndex 2
      symbols {allDownlink}
   }
   {slotIndex 3
      Symbols {explicit
{nrofDownlinkSymbols=4
   nrofUplinkSymbols=6}
      }
}
}

After completing interference measurements (i.e., received CQI from Set1-UEs), the CSI-IM/ZP-CSI-RS configurations for the Set1-UE is changed and semi-persistent SRS is deactivated for the Set2-UE. Thus, the TDD-UL-DL-ConfigDedicated for the Set1-UE (after interference monitoring has been performed) might include the following information:
TDD-UL-DL-ConfigDedicated
{slotSpecificConfigurationsToAddModList
   {slotIndex 2
      symbols {allDownlink}
   }
   {slotIndex 3
      Symbols {explicit
{nrofDownlinkSymbols=6
   nrofUplinkSymbols=4}
      }
}
}

Additionally, the TDD-UL-DL-ConfigDedicated for Set2-UE can be reconfigured to use slot #2 as special slot and slot #3 as UL slot. For example, slot #2 can be configured with format 10d:4g. Thus, after sending the SRS, the TDD-UL-DL-ConfigDedicated for the Set2-UE (interference generating UE 110) might include the following information:
TDD-UL-DL-ConfigDedicated
{slotSpecificConfigurationsToAddModList
   {slotIndex 2
      symbols {explicit
{nrofDownlinkSymbols=10
   nrofUplinkSymbols=0}
      }
   }
   {slotIndex 3
      symbols {allUplink}
   }
}

PDSCH and PUSCH can be scheduled for Set1-UE and Set2-UE, respectively, on slot #3. After a certain time duration, TDD-UL-DL-ConfigDedicated for Set2-UE can be reconfigured to use the initial configuration. Additionally, RUs 106 are configured for DL or UL according to the configuration of their respective UEs 110.

### Example 2

FIG. 10C illustrates another TDD-UL-DL-ConfigCommon, which has the same pattern1 as in FIG. 10A, but its pattern2 includes only undefined slots 122/symbols 124 (interpreted as flexible), which can then be redefined in the TDD-UL-DL-ConfigDedicated (dedicated configuration). Specifically, when slots #6, 7, 8, 9 are configured as DLslots in the TDD-UL-DL-ConfigDedicated, the same overall pattern as in FIG. 10A can be achieved.

Therefore, Example 2 (and corresponding FIG. 10C) represents a further modification in the dedicated configuration where you can specify specific symbols within a slot. When a UE attaches to an eNB and establishes a configuration (a UE context), the eNB sends an RRC configuration message that includes the dedicated configuration for the UE. Then, if the UE's traffic demand changes (e.g., to need more uplink slots), an RRC reconfiguration message can be sent with a modified dedicated configuration based on the UE's traffic demand changes

Since switching time is not required from UL to DL symbols 124 or slots 122, slot #6-sym #13 is used for CSI-IM measurement. Additional semi-persistent SRS with periodicity 10 ms may be configured for all UEs 110. Hence, the semi-persistent SRS is configured as:
nrofSRS-Ports=4,
resourceMapping={startPosition=0 (i.e., sym #13), nrofSymbols=1}
freqDomainShift=0 (i.e., startRB=0)
freqHopping uses largest SRS BW<=channel BW, no hopping
periodicityAndOffset=sl10 (6).

Unlike Example 1, the semi-persistent SRS is configured on symb #13 of slot #6 in Example 2.

The TDD-UL-DL-ConfigCommon information element associated with FIG. 10C broadcast to UEs 110 may have the following information in it to start with:
TDD-UL-DL-ConfigCommon
{referenceSubcarrierSpacing=kHz30
pattern1={dl-UL-TransmissionPeriodicity=2.5 ms
   nrofDownlinkSlots=3
   nrofDownlinkSymbols=6
   nrofUplinkSlots=2
   nrofUplinkSymbols=4
   dl-UL-TransmissionPeriodicity-v1530=3 ms}
pattern2={dl-UL-TransmissionPeriodicity=2 ms
   nrofDownlinkSlots=0
   nrofDownlinkSymbols=0
   nrofUplinkSlots=0
   nrofUplinkSymbols=0}

The TDD-UL-DL-ConfigDedicated information element associated with FIG. 10C broadcast to UEs 110 may have the following information in it:
TDD-UL-DL-ConfigDedicated
{slotSpecificConfigurationsToAddModList
   {slotIndex 6
      symbols {allDownlink}
   }
   {slotIndex 7
      symbols {allDownlink}
   }
   {slotIndex 8
      symbols {allDownlink}
   }
   {slotIndex 9
      symbols {allDownlink)
   }
}

With reference to Example 2 as illustrated in FIG. 10C, the TDD-UL-DL-ConfigDedicated is initially used to reconfigure slots #6-10 to DL slots. Assume criteria are developed to select UEs (Set1-UE) to monitor interference in slot #6, to select UEs (Set2-UE) to generate interference in slot #6. Here, there is no need to change TDD pattern for Set1-UE since slot #6 is already a DL slot.

Still with reference to Example 2, 3 CSI-IM, 3 ZP-CSI-RS resources are configured for the Set1-UE on slot #6-sym #13. For example, CSI-IM-Resources can be configured as follows: Pattern1, symbolLocation-p1=13, subcarrierLocation-p1=s0, s4, s8 respectively. The ZP-CSI-RS can be configured as follows: firstOFDMSymbolInTimeDomain=13 with row4=001, 010, 100 respectively. Both CSI-IM and ZP-CSI-RS can be configured to use nrofPorts=4, freqBand=full channel BW. Both CSI-IM and ZP-CSI-RS can be configured with a periodicity of 10 ms. Thus, there is no need to change the initial TDD-UL-DL-ConfigDedicated for the Set1-UE (i.e., to use the configuration given in paragraphs [0225]-[0253] for monitoring CSI-IM on slot #6-symb #13).

For Set2-UE, TDD-UL-DL-ConfigDedicated can be reconfigured such that slot #6-sym #13 is a UL symbol (9d:4g:1u). Then, semi-persistent SRS can be used for Set2-UE (interference generating UE 110) and CQI measurements can be configured for Set1-UE (interference measuring UE 110). And the TDD-UL-DL-ConfigDedicated for the Set2-UE (interference generating UE 110) might include the following information:
TDD-UL-DL-ConfigDedicated
{slotSpecificConfigurationsToAddModList
   {slotIndex 6
      Symbols {explicit
{nrofDownlinkSymbols=9
   nrofUplinkSymbols=1}
      }
   {slotIndex 7
      symbols {allDownlink}
}
   {slotIndex 8
      symbols {allDownlink}
}
   {slotIndex 9
      symbols {allDownlink}
}
}

After completing interference measurements (i.e., received CQI from Set1-UEs), the CSI-IM/ZP-CSI-RS configurations are removed for the Set1-UE and semi-persistent SRS is deactivated for the Set2-UE. There's no need to change TDD pattern for Set1-UE, since slot #6 is already a DL slot.

Additionally, the TDD-UL-DL-ConfigDedicated for Set2-UE can be reconfigured to use slot #6 as an UL slot. Thus, after sending the SRS, the TDD-UL-DL-ConfigDedicated for the Set2-UE (interference generating UE 110) might include the following information:
TDD-UL-DL-ConfigDedicated
{slotSpecificConfigurationsToAddModList
   {slotIndex 6
      symbols {allUplink}
}
   {slotIndex 7
      symbols {allDownlink}
}
   {slotIndex 8
      symbols {allDownlink}
}
   {slotIndex 9
      symbols {allDownlink}
}
}

PDSCH and PUSCH can be scheduled for Set1-UE and Set2-UE, respectively, on slot #6. After a certain time duration, TDD-UL-DL-ConfigDedicated for Set2-UE can be reconfigured to use the initial configuration.

### Method of Configuring DL/UL Reuse in the Same Time and Frequency Resource

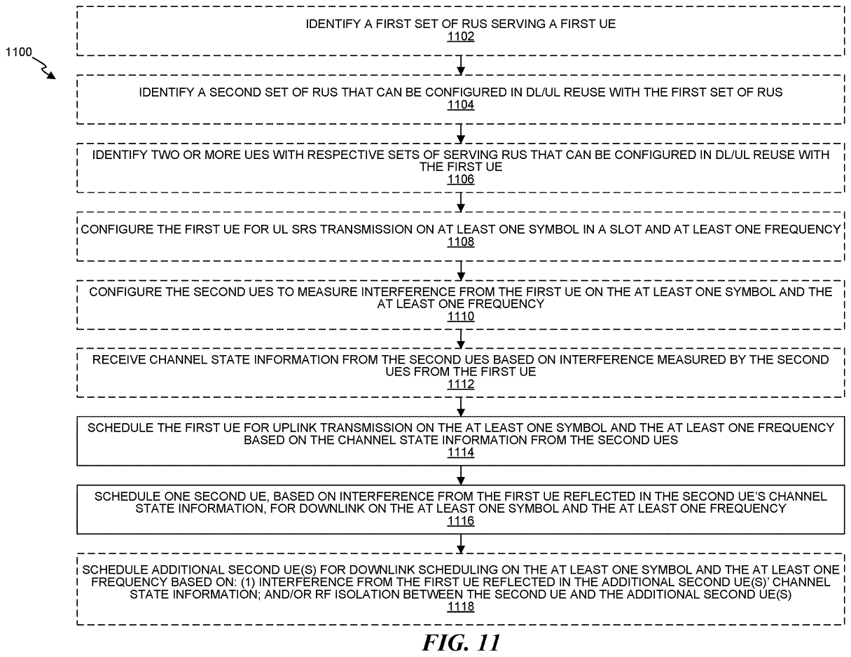

FIG. 11 is a flow diagram illustrating a method 1100 for DL/UL reuse in the same time and frequency resource. The method 1100 may be performed, at least partially, by a gNodeB or an eNodeB, e.g., implemented by a C-RAN 100. In some examples, the method 1100 may be performed by a central entity, such as a CU 103, a DU 105, or baseband controller 104 in a communication system 101. The central entity may be implemented in at least one computing device that includes at least one processor executing instructions stored in memory.

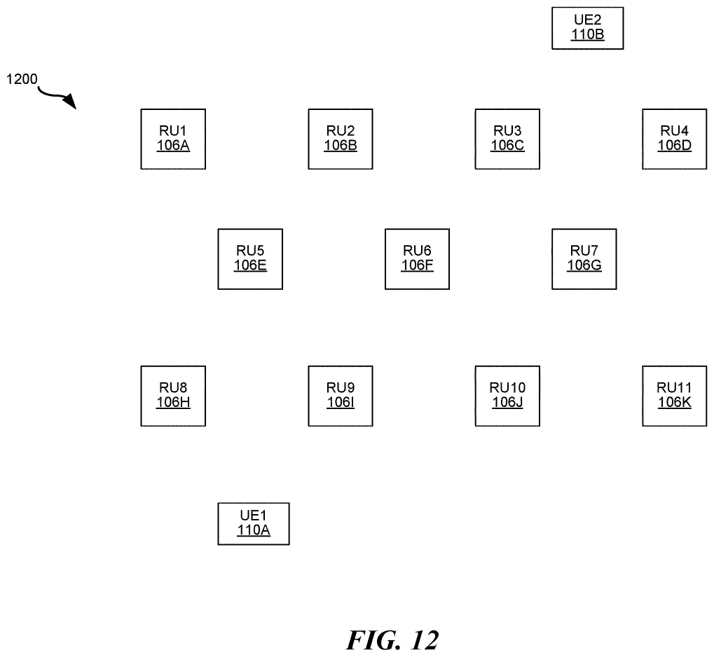

FIG. 12 is a block diagram of a plurality of RUs 106A-K in an example system 1200. FIG. 12 is used to illustrate certain concepts in the method 1100 of FIG. 11. However, it is understood that the method 1100 of FIG. 11 could be used with different systems having different numbers and/or configuration of RUs 106.

The blocks of the flow diagram shown in FIG. 11 have been arranged in a generally sequential manner for ease of explanation; however, it is to be understood that this arrangement is merely exemplary, and it should be recognized that the processing associated with method 1100 (and the blocks shown in FIG. 11) can occur in a different order (for example, where at least some of the processing associated with the blocks is performed in parallel and/or in an event-driven manner). Also, most standard exception handling is not described for ease of explanation; however, it is to be understood that method 1100 can and typically would include such exception handling.

In some configurations, before the method 1100 is performed, cross-RU interference is measured at each of the RUs 106 in a second set of RUs 106 from each of the RUs 106 in a first set of RUs 106. For example, if the interference at a particular RU 106 in the second set of RUs 106 (received from an RU 106 in the first set of RUs 106) is lower than a cross-RU interference threshold then the interference can be ignored because it would not prevent desired uplink signals from UEs 110 from being received at the RU 106 in the second set of RUs 106. This process can be repeated for every RU 106 in the first set of RUs in combination with every RU 106 in the second set of RUs 106.

For example, for each RUi (i={1 . . . n}): (1) RUi is scheduled to transmit a known signal (e.g., CSI-RS); (2) RUj (j={1 . . . n} and J #i) is scheduled to measure the received power; and (3) for each RUi, all RUj with receive power less than a cross-RU interference threshold are compiled into a list. The list of RUj is then the list of RUs 106 that may participate in DL/UL reuse with RUi. Thus, at the end of the measurement process, a list has been compiled that indicates, for each RU 106, which other RU(s) 106 will have problematic interference and which will not be problematic.

The method 1100 begins at optional step 1102 where the central entity identifies the first set of RUs 106 (e.g., in a first zone) serving a first UE 110, e.g., the combining zone of the first UE 110. For example, the first UE 110 may be a UE 110 with high UL demand that needs a higher than normal UL allocation of resources. As described above, a central entity may determine the relative location of a UE 110 by ranking the signal strength of the wireless device's signal(s) across all RUs 106 and picking the top RUs 106 (e.g., the top three or four RUs 106) to be in the UE's combining zone. For example, with reference to FIG. 12, the combining zone for UE1 11 OA may include RU8 106H, RU5 106E, and RU9 106I, e.g., the RUs 106 that UE1 110A receives the strongest signal from.

The method 1100 proceeds at optional step 1104 where the central entity identifies the second set of RUs 106 (e.g., in a second zone 109) that can be configured in DL/UL reuse with the first set of RUs 106. The first set of RUs 106 and the second set of RUs 106 may be part of the same cell(s) 102, e.g., the first set of RUs 106 and the second set of RUs 106 may broadcast the same Cell-ID (or Cell-IDs).

With reference to FIG. 12 again, the second set of RUs 106 that can be in DL/UL reuse with the first set of RUs (RU8 106H, RU5 106E, and RU9 106I) from optional step 1102 are the intersection of the RUs 106 that have low cross-RU interference with each of RU8 106H, RU5 106E, and RU9 106I. That is, in the configuration of FIG. 12, the second set of RUs={RU2, RU3, RU4, RU6, RU7, RU 11}∩{RU3, RU4, RU7, RU10, RU11}∩{RU2, RU3, RU4, RU6, RU7, RU11}={RU3, RU4, RU7, RU11}(where A∩B=the set of all elements common to A and B). Thus, UEs 110 being serviced by RUs 3, 4, 7, and 11 can be considered as second UEs 110 below, e.g., in optional steps 1110 through 1118.

The method 1100 proceeds at optional step 1106 where the central entity identifies two or more second UEs 110 with respective sets of serving RUs 106 that can be configured in DL/UL reuse with the first UE 110 of optional step 1102. For example, using the list from optional step 1104, the central entity can determine two UEs 110 (served by respective sets of RUs 106 with low cross-RU measurements) that are candidates for DL/UL reuse, e.g., RUs in the second set of RUs 106 that have low cross-RU interference with the first set of RUs 106 of optional step 1102.

The method 1100 proceeds at optional step 1108 where the central entity configures the first UE 110 for UL SRS transmission on at least one symbol 124 of slot 122 and at least one frequency. For example, the first UE 110 can be configured to transmit the SRS on the at least one symbol 124 in a slot 122 and at least one frequency that the second UE(s) 110 are configured to measure interference on. The second UEs 110 can be configured to not transmit during the at least one symbol 124 in a slot 122 and at least one frequency.

The SRS may be transmitted on one, two, or four consecutive symbols 124. The SRS can be transmitted in any of the last six symbols 124 of a slot 122 (symbol #8-#13). The starting RB 126, SRS bandwidth (in RBs 126), and SRS hopping bandwidth (in subcarriers 128) can be configured. The SRS hopping bandwidth occupies contiguous RBs 126.

One or more SRS can be sent on the same symbol(s). In 5G, the SRS could be transmitted on one, two, or four consecutive symbols 124. In comb2 configurations, the SRS is transmitted in every other subcarrier 128 of an RB 126 used for SRS. There are two comb offsets for comb2: 0,1. When a UE 110 is configured to use offset=0, it transmits SRS on subcarriers 0, 2, 4, . . . . When a UE 110 is configured to use offset=1, it transmits SRS on subcarrier 1, 3, 5, . . . . Up to 8 UEs can be multiplexed on same offset by using 8 different cyclic shifts in comb2 configurations. FIG. 7A is one example of a comb2 configuration for multiplexing two SRS signals in the same symbol(s) 124.

In comb4 configurations, SRS is transmitted in every four subcarriers 128. There are 4 comb4 offsets:0,1,2,3. Up to 12 UEs 110 can be configured to transmit SRS on same comb offset by using different cyclic shifts. Up to 12 UEs can be multiplexed on same offset by using 12 different cyclic shifts in comb2 configurations. FIG. 7B is one example of a comb4 configuration for multiplexing four SRS signals in the same symbol(s) 124. SRS uses either comb2 or comb4 (not comb1).

The right side of FIG. 8 illustrates a particular comb2 configuration that the first UE 110 could use to transmit a Sounding Reference Signal (SRS), similar to the left portion of FIG. 7A. The bandwidth shown in FIG. 8 is the largest allowed for SRS that is less than or equal to the channel bandwidth and may not use hopping if the fronthaul bandwidth allows. Four antenna ports may be used for CSI-IM, ZP-CSI-RS, and SRS. It should be noted that FIG. 8 only shows the configurations in 1 PRB, however CSM-IM, AP-CSI-RS, SRS may be configured for full channel BW (e.g., 2 PRBs).

The method 1100 proceeds at optional step 1110 where the central entity configures the second UE(s) 110 to measure interference from the first UE 110 on the at least one symbol 124 and the at least one frequency. This may include configuring the CSI-IM and/or the ZP-CSI-RS for the second UEs 110 to ensure they (1) don't transmit on the at least one symbol 124 and the at least one frequency; and (2) measure interference on the at least one symbol 124 and the at least one frequency.

The CSI-IM resource is used by the second UE(s) 110 to estimate interference and noise. The ZP-CSI-RS indicates to second UE(s) 110 that none of the RUs 106 will transmit on the at least one symbol 124 and the at least one frequency. The CSI-IM and ZP-CSI-RS can be configured using one of two patterns of four REs 127 each, as outlined in FIGS. 6A-6B. The starting RB 126, the starting symbol 124, and the number of RBs can be configured for CSI-IM. A communication system 101 may use 4 antenna ports for TDD.

The left side of FIG. 8 is an example of how 3 pattern1 CSI-IM resources (with symbol location at symbol #8 and starting subcarrier locations at subcarriers #0, 4, and 8, respectively) and 3 row-4 ZP-CSI-RS resources (with symbol location at symbol #8 and the starting subcarrier as ‘001’, ‘010’, ‘100’, respectively) for UEs 110 to measure the interference from neighbor cells and from the first UE 110 that transmits SRS on symbol #8. The entire frequency channel bandwidth (all subcarriers 128) can be configured for the second UE(s) 110 to measure the interference.

The method 1100 proceeds at optional step 1112 where the central entity receives channel state information (e.g., CQI, PMI, RI, and/or LI) from the second UE(s) 110 based on interference measured by the second UE(s) 110 from the first UE 110.

The method 1100 proceeds at step 1114 where the central entity schedules the first UE 110 for uplink transmission on the at least one symbol 124 and the at least one frequency based on the channel state information from the second UE(s) 110.

The method 1100 proceeds at step 1116 where the central entity schedules one second UE 110B, based on interference from the first UE 110 reflected in the second UE's channel state information (e.g., CQI, PMI, RI, and/or LI), for downlink on the at least one symbol 124 and the at least one frequency (the same symbol and the same (or overlapping frequency) that the first UE 110 is scheduled on for UL transmission). For example, the central entity may select one of the second UE(s) 110 that has reported the highest CQI to schedule for downlink (the same symbol that the first UE 110 is scheduled on for UL transmission). A higher CQI reported by the second UE 110B can be used to infer a lower interference measured at the second UE 110B. Thus, the central entity may schedule the second UE 110B for DL, on the same symbol and frequency that the first UE 110 is scheduled on for UL transmission, on the basis of a higher CQI reported by the second UE 110B (because the second UE 110B measured lower interference from the first UE 110). Conversely, a different second UE 110 may not be scheduled for DL, on the same symbol and frequency that the first UE 110 is scheduled on for UL transmission, on the basis of a lower CQI reported by the different second UE 110.

The method 1100 proceeds at optional step 1118 where the central entity schedule additional second UE(s) 110 for downlink scheduling on the at least one symbol 124 and the at least one frequency based on: (1) interference from the first UE 110 reflected in the additional second UE(s)' channel state information (e.g., a CQI reported by the additional second UE(s) 110 is higher than a CQI threshold and therefore used to infer a lower interference measured at the additional second UE(s)); and/or (2) RF isolation between the already-scheduled second UE 110 (in step 1116) and the additional second UE(s) 110, e.g., such that the RUs 106 transmissions to the second UE(s) 110 don't interfere with the additional second UE(s) 110 ability to receive from their own serving RUs 106 and vice versa.

In other words, additional second UE(s) 110 can optionally be scheduled for DL on the same symbol and frequency used by the first UE 110A (for UL) and the second UE 110B (in DL) based on cross-UE interference between the first UE 110 and the additional second UE(s) 110 and cross RU-UE interference between the second UEs serving RUs 106 and the additional second UE(s) 110.

Low cross-UE interference in optional step 1118 (here referring to the interference between the transmission of the first UE 110 to the reception of the additional second UE(s) 110) may indicate RF isolation between the additional second UE(s) 110 and the first UE 110 and may be inferred based on CQI reported by the additional second UE(s) 110, e.g., lower cross-UE interference may be inferred from higher CQI reported by the additional second UE(s) 110.

Low cross RU-UE interference in optional step 1118 (here referring to interference generated by the second UEs serving RUs 106 and measured at the additional second UE(s) 110) indicates RF isolation between the second UE 110B and the additional second UE(s) 110. Cross RU-UE interference may be measured using the reuse method in which all RUs 106 measure the SRS power they receive from UEs 110 and generate a Signature Vector from the SRS powers.

Following the scheduling in the method 1100, the first UE 110 may transmit uplink wireless signals on the at least one symbol 124 and the at least one frequency and the second set of RUs 106 transmit downlink wireless signals to the one second UE 110 on the at least one symbol 124 and the at least one frequency.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. For example, where a computing device is described as performing an action, the computing device may carry out this action using at least one processor executing instructions stored on at least one memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### TERMINOLOGY

Brief definitions of terms, abbreviations, and phrases used throughout this application are given below.

The term “determining” and its variants may include calculating, extracting, generating, computing, processing, deriving, modeling, investigating, looking up (e.g., looking up in a table, a database or another data structure), ascertaining and the like. Also, “determining” may also include receiving (e.g., receiving information), accessing (e.g., accessing data in a memory) and the like. Also, “determining” may include resolving, selecting, choosing, establishing and the like.

The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

The terms “connected”, “coupled”, and “communicatively coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in exemplary configurations”, “in example configurations”, “in some configurations”, “according to some configurations”, “in the configurations shown”, “in other configurations”, “configurations”, “in examples”, “examples”, “in some examples”, “some examples” and the like generally mean the particular feature, structure, or characteristic following the phrase is included in at least one configuration of the present disclosure, and may be included in more than one configuration of the present disclosure. In addition, such phrases do not necessarily refer to the same configurations or different configurations.

If the specification states a component or feature “may,” “can,” “could,” or “might” be included or have a characteristic, that particular component or feature is not required to be included or have the characteristic.

The terms “responsive” or “in response to” may indicate that an action is performed completely or partially in response to another action.

In conclusion, the present disclosure provides novel systems, methods, and arrangements for spectrum-efficient utilization of an uplink control channel. While detailed descriptions of one or more configurations of the disclosure have been given above, various alternatives, modifications, and equivalents will be apparent to those skilled in the art without varying from the spirit of the disclosure. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting.

### Examples

Example 1 includes a communication system for downlink/uplink reuse in a same time and frequency resource, comprising: a plurality radio unit (RUs) in a cell, wherein a first set of RUs serves a first user equipment (UE) and a second set of RUs serves second UEs; and a central entity communicatively coupled to the plurality of radio units via a fronthaul network, the central entity configured to: schedule the first UE for uplink transmission on at least one symbol and at least one frequency; and schedule a second UE, based on interference from the first UE reflected in the second UE's channel state information, for downlink on the at least one symbol and the at least one frequency.

Example 2 includes the communication system of Example 1, wherein the central entity is further configured to identify the first set of RUs as the combining zone of the first UE.

Example 3 includes the communication system of Example 2, wherein the combining zone of the first UE comprises RUs that receive wireless signals from the first UE with the highest signal strength among the plurality of RUs.

Example 4 includes the communication system of any of Examples 1-3, wherein the central entity is further configured to identify the second set of RUs as the RUs that generate interference to the first set of RUs below a cross-RU interference threshold.

Example 5 includes the communication system of any of Examples 1-4, wherein the central entity is further configured to configure the first UE to transmit a sounding reference signal (SRS) on the at least one symbol and the at least one frequency.

Example 6 includes the communication system of any of Examples 1-5, wherein the central entity is further configured to configure the second UEs to measure interference from the first UE on the at least one symbol and the at least one frequency.

Example 7 includes the communication system of Example 6, wherein configuring the second UEs to measure interference from the first UE on the at least one symbol and the at least one frequency comprises configuring: a channel state information interference measurement (CSI-IM) to indicate to the second UEs the at least one symbol and the at least one frequency to measure interference on; and a zero-power channel state information reference signal (ZP-CSI-RS) for the second UEs to ensure that no downlink transmissions affect interference measurements done by the second UEs.

Example 8 includes the communication system of any of Examples 1-7, wherein the central entity is further configured to schedule at least one additional second UE for downlink scheduling on the at least one symbol and the at least one frequency based on the following: interference from the first UE reflected in channel state information from the at least one additional second UE; and radio frequency isolation between the second UE and the at least one additional second UE.

Example 9 includes the communication system of any of Examples 1-8, wherein the first UE transmits uplink wireless signals on the at least one symbol and the at least one frequency; and wherein the second set of RUs transmit downlink wireless signals to the one second UE on the at least one symbol and the at least one frequency.

Example 10 includes the communication system of any of Examples 1-9, wherein the plurality of RUs broadcast a same Cell-ID.

Example 11 includes a method for downlink/uplink reuse in a same time and frequency resource, the method being performed by a central entity that is communicatively coupled with a first set of RUs in a cell that serve a first user equipment (UE) and a second set of RUs in the cell that serve second UEs, the method comprising: scheduling the first UE for uplink transmission on at least one symbol and at least one frequency; and scheduling a second UE, based on interference from the first UE reflected in the second UE's channel state information, for downlink on the at least one symbol and the at least one frequency.

Example 12 includes the communication system of Example 11, further comprising identifying the first set of RUs as the combining zone of the first UE.

Example 13 includes the communication system of Example 12, wherein the combining zone of the first UE comprises RUs that receive wireless signals from the first UE with the highest signal strength among the plurality of RUs.

Example 14 includes the communication system of any of Examples 11-13, further comprising identifying the second set of RUs as the RUs that generate interference to the first set of RUs below a cross-RU interference threshold.

Example 15 includes the communication system of any of Examples 11-14, further comprising configuring the first UE to transmit a sounding reference signal (SRS) on the at least one symbol and the at least one frequency.

Example 16 includes the communication system of any of Examples 11-15, further comprising configuring the second UEs to measure interference from the first UE on the at least one symbol and the at least one frequency.

Example 17 includes the communication system of Example 16, wherein configuring the second UEs to measure interference from the first UE on the at least one symbol and the at least one frequency comprises configuring: a channel state information interference measurement (CSI-IM) to indicate to the second UEs the at least one symbol and the at least one frequency to measure interference on; and a zero-power channel state information reference signal (ZP-CSI-RS) for the second UEs to ensure that no downlink transmissions affect interference measurements done by the second UEs.

Example 18 includes the communication system of any of Examples 11-17, further comprising scheduling at least one additional second UE for downlink scheduling on the at least one symbol and the at least one frequency based on the following: interference from the first UE reflected in channel state information from the at least one additional second UE; and radio frequency isolation between the second UE and the at least one additional second UE.

Example 19 includes the communication system of any of Examples 11-18, wherein the first UE transmits uplink wireless signals on the at least one symbol and the at least one frequency; and wherein the second set of RUs transmit downlink wireless signals to the one second UE on the at least one symbol and the at least one frequency.

Example 20 includes the communication system of any of Examples 11-19, wherein the plurality of RUs broadcast a same Cell-ID.

1. A communication system for downlink/uplink reuse in a same time and frequency resource, comprising:
a plurality radio unit (RUs) in a cell, wherein a first set of RUs serves a first user equipment (UE) and a second set of RUs serves second UEs; and
a central entity communicatively coupled to the plurality of radio units via a fronthaul network, the central entity configured to:
schedule the first UE for uplink transmission on at least one symbol and at least one frequency; and
schedule a second UE, based on interference from the first UE reflected in the second UE's channel state information, for downlink on the at least one symbol and the at least one frequency.

2. The communication system of claim 1, wherein the central entity is further configured to identify the first set of RUs as a combining zone of the first UE.

3. The communication system of claim 2, wherein the combining zone of the first UE comprises RUs that receive wireless signals from the first UE with a highest signal strength among the plurality of RUs.

4. The communication system of claim 1, wherein the central entity is further configured to identify the second set of RUs as the RUs that generate interference to the first set of RUs below a cross-RU interference threshold.

5. The communication system of claim 1, wherein the central entity is further configured to configure the first UE to transmit a sounding reference signal (SRS) on the at least one symbol and the at least one frequency.

6. The communication system of claim 1, wherein the central entity is further configured to configure the second UEs to measure interference from the first UE on the at least one symbol and the at least one frequency.

7. The communication system of claim 6, wherein configuring the second UEs to measure interference from the first UE on the at least one symbol and the at least one frequency comprises configuring:
a channel state information interference measurement (CSI-IM) to indicate to the second UEs the at least one symbol and the at least one frequency to measure interference on; and
a zero-power channel state information reference signal (ZP-CSI-RS) for the second UEs to ensure that no downlink transmissions affect interference measurements done by the second UEs.

8. The communication system of claim 1, wherein the central entity is further configured to schedule at least one additional second UE for downlink scheduling on the at least one symbol and the at least one frequency based on the following:
interference from the first UE reflected in channel state information from the at least one additional second UE; and
radio frequency isolation between the second UE and the at least one additional second UE.

9. The communication system of claim 1, wherein the first UE transmits uplink wireless signals on the at least one symbol and the at least one frequency;
wherein the second set of RUs transmit downlink wireless signals to the one second UE on the at least one symbol and the at least one frequency.

10. The communication system of claim 1, wherein the plurality of RUs broadcast a same Cell-ID.

11. A method for downlink/uplink reuse in a same time and frequency resource, the method being performed by a central entity that is communicatively coupled with a plurality of RUs in a cell having a first set of RUs that serve a first user equipment (UE) and a second set of RUs in the cell that serve second UEs, the method comprising:
scheduling the first UE for uplink transmission on at least one symbol and at least one frequency; and
scheduling a second UE, based on interference from the first UE reflected in the second UE's channel state information, for downlink on the at least one symbol and the at least one frequency.

12. The method of claim 11, further comprising identifying the first set of RUs as a combining zone of the first UE.

13. The method of claim 12, wherein the combining zone of the first UE comprises RUs that receive wireless signals from the first LIE with a highest signal strength among the plurality of RUs.

14. The method of claim 11, further comprising identifying the second set of RUs as the RUs that generate interference to the first set of RUs below a cross-RU interference threshold.

15. The method of claim 11, further comprising configuring the first UE to transmit a sounding reference signal (SRS) on the at least one symbol and the at least one frequency.

16. The method of claim 11, further comprising configuring the second UEs to measure interference from the first UE on the at least one symbol and the at least one frequency.

17. The method of claim 16, wherein configuring the second UEs to measure interference from the first UE on the at least one symbol and the at least one frequency comprises configuring:
a channel state information interference measurement (CSI-IM) to indicate to the second UEs the at least one symbol and the at least one frequency to measure interference on; and
a zero-power channel state information reference signal (ZP-CSI-RS) for the second UEs to ensure that no downlink transmissions affect interference measurements done by the second UEs.

18. The method of claim 11, further comprising scheduling at least one additional second UE for downlink scheduling on the at least one symbol and the at least one frequency based on the following:
interference from the first UE reflected in channel state information from the at least one additional second UE; and
radio frequency isolation between the second UE and the at least one additional second UE.

19. The method of claim 11, wherein the first UE transmits uplink wireless signals on the at least one symbol and the at least one frequency;
wherein the second set of RUs transmit downlink wireless signals to the one second UE on the at least one symbol and the at least one frequency.

20. The method of claim 11, wherein the plurality of RUs broadcast a same Cell-ID.
